(19) United States
(12) Patent Application Publication
(10) Pub. No.: US 2021/0316513 A1
(43) Pub. Date: Oct. 14, 2021

(54) METHOD FOR PRODUCING A COMPOSITE PROFILE

(71) Applicant: Ensinger GmbH, Nufringen (DE)

(72) Inventors: Michael MÖLLER, Cham (DE); Bernhard KÖNIGSBERGER, Cham (DE); Gerhard GÖTTLINGER, Cham (DE)

(21) Appl. No.: 17/225,052

(22) Filed: Apr. 7, 2021

(30) Foreign Application Priority Data
Apr. 8, 2020 (DE) 10 2020 109 830.8

(51) Int. Cl. B29C 65/08; B29C 65/00

(52) U.S. Cl. CPC B29C 65/08; B29C 66/721; B29C 66/12425; B29C 66/30223; B29L 2031/003; B29C 66/5241; B29C 66/7315; B29C 66/742; B29C 66/8322; B29C 66/30325

(57) ABSTRACT

A method for producing composite profiles comprises providing a first profile part extending in a longitudinal direction, made from a first plastics material, with a profile region produced from a second plastics material thermally plasticizable at a first temperature,
providing a second profile part extending in a longitudinal direction, made from a material not thermally plasticizable at the first temperature, and with a receiving structure formed along the longitudinal direction of the second profile part, with which the profile region of the first profile part is connectible,
bringing the profile region of the first profile part into contact with the receiving structure of the second profile part,
plasticizing the second plastics material of the profile region by heating to the first temperature and
deforming the plasticized profile region while forming a positive engagement between the profile region and the receiving structure while maintaining the geometry of the receiving structure.

### CROSS-REFERENCE TO RELATED APPLICATIONS

This patent application claims the benefit under 35 USC 119(b) of German Application No. 10 2020 109 830.8 of Apr. 8, 2020, which is incorporated herein by reference.

### BACKGROUND OF THE INVENTION

The invention relates to a method for producing composite profiles extending in a longitudinal direction, in particular plastic-metal composite profiles connected by positive engagement or form fit, and composite profiles produced using this method, which are suitable in particular for use in demanding construction applications, for example in the construction sector in the production of windows, doors, and façade elements or in equipment construction, scaffolding, housing construction, or in the manufacture of vehicles (ground vehicles, aircraft, watercraft).

Conventional composite profiles are, e.g., plastic-metal composite profiles, the profile parts of which are produced from different materials, which in particular are widely used for the aforementioned different purposes.

In the case of composite profiles that are, for example, widely used in the construction industry, one often utilizes the combination of the respective advantageous properties of plastic and metal, e.g., the good ductility and permanence of metals and the low weight, the good shapeability and the good insulating properties (electrical, thermal) of plastics materials.

Such composite profiles are widely used in the field of metal windows, metal doors, and in façade technology. Typically, easily producible aluminum profiles are connected by plastic profiles in order to produce therefrom façade elements, windows, doors, or other building openings (e.g. ventilation apertures etc.).

The conventional connection technology uses a roll-in technology for connecting the plastic and metal profiles by positive engagement in different versions.

Typically, a plastic profile with so-called roll-in feet is first loosely introduced into a metal profile with a matching geometric receptacle and then are finally fixed by positive engagement by deforming a metallic profile component (so-called “hammer”) by rolling in. The roll-in foot of the plastic profile is then held in positive engagement by the metallic “hammer” and a metallic “anvil”. The metal profile is optionally provided with a surface structure in the region of the receptacle, for example knurled, in order to improve a transmission of force in the region of the positive engagement.

Special solutions are also used, for example the adhesive bonding of plastic profiles as a substance-to-substance or material bond. It should generally be noted that composite profiles for windows and façade applications may constitute safety-related components, which in Germany, for example, are tested for suitability according to DIN EN 14024.

Disadvantages of the previously established method for producing composite profiles for windows, door, façades, namely rolling plastic profiles (e.g. extruded profiles made from PA66 GF25 into extruded aluminum profiles) into metal profiles:

problems when threading or inserting the plastic profiles into the corresponding grooves of the aluminum profiles, for example due to superficial accumulations of dirt, burrs, dimensional deviations or fluctuations;

higher (cost) expenditure to increase the shear strength of the plastic-metal connection, for example by knurling the aluminum profiles, by introducing into the plastic profiles metal wires that are conducive to shear strength;

limited ability to improve the torsional rigidity in existing composite designs;

fluctuating strength of the plastic-metal connection due to wear to the roll-in systems, geometry deviations, and dimensional fluctuations of the joining partners, aging phenomena of the materials (moisture, heat);

a continuous 100% inspection for quality assurance is not possible in the roll-in method;

limited freedom of design or unpleasant appearance due to visible marks from knurling/rolling-in;

little flexibility in the method to, for example, comply with requirements of the customer or legislation for increased thermal insulation, e.g. reduction of thermal transition (U_{f}) values, to achieve energy savings targets.

The different problems stated above are addressed in the prior art in a variety of ways.

In the journal Kunststoffe in Volume 1/2018, beginning on p. 29, a concept for connecting plastic and metal profile segments by positive engagement for the production of composite profile segments for window/door/façade applications is described using a short profile sample. Here, the metal part is roughened or structured by means of a laser beam in order to produce a multiplicity of fine undercuts, which then form a so-called adhesive base for a plastic profile. The plastic component is connected to the metal part. The plastic is then superficially melted by the metal component being heated by means of a laser beam or inductively heated, and pressed into the structure of the metal part. The article shows a short profile sample, clearly connected by form fit or positive engagement, of a length that corresponds roughly to the width of a hand, but does not teach how the plastic is superficially melted or how a longer composite profile, for example of several meters, can be produced. The costs of such a laser structuring of the aluminum component are relatively high, which is due to the low surface speeds of the laser structuring and typically high acquisition and maintenance costs. This is in conflict with the requirement of an economical joining process.

EP 1 510 383 A2 describes a guidance rail, produced by injection moulding, made of different materials, among other things thermoplastic materials. Alternatively, further components can be connected at points by substance-to-substance bond by means of ultrasound.

The pressing or clipping of metal profiles or strips into or onto plastic profiles, wherein no thermal energy is added and a composite component is created directly by way of a positive engagement or cold deformation, is described in WO 2017/186722 A1 and also previously in DE 32 36 357 A1. Here, the partial covering of plastic profiles is achieved by metallic bands.

In accordance with an embodiment of the invention, an economical method for producing composite profiles of the kind described at the outset is provided, which in particular creates a permanent, solid bond of the profile parts, wherein the obtained composite profile moreover has good properties for use in technically demanding construction applications. These construction applications include, in particular, applications in the construction sector, primarily in the production of window, door, and façade profiles, and window, door, and façade elements produced therefrom.

### SUMMARY OF THE INVENTION

In accordance with an embodiment of the invention, a method for producing a composite profile extending in a longitudinal direction is provided, comprising providing a first profile part extending in a longitudinal direction, made from a first plastics material, with a profile region, wherein the profile region of the first profile part is produced from a second plastics material that is thermally plasticizable at a first temperature T₁,

providing a second profile part extending in a longitudinal direction, which is produced from a material that is not thermally plasticizable at the first temperature T₁, wherein the second profile part has a receiving structure formed along the longitudinal direction of the second profile part, to which the profile region of the first profile part is connectible by positive engagement,
bringing the profile region of the first profile part into contact with the receiving structure of the second profile part,
plasticizing the second plastics material of the profile region of the first profile part by heating to the first temperature T₁ and
deforming the plasticized second plastics material of the profile region of the first profile part while forming a positive engagement between the profile region of the first profile part and the receiving structure of the second profile part, wherein the receiving structure has a geometry that remains substantially unchanged during formation of the positive engagement.

Thus, the composite profile to be produced in accordance with the invention comprises at least two profile parts, which each extend in a longitudinal direction and differ from one another in their material composition. A first profile part is produced from a first plastics material and comprises a profile region made of a second plastics material that is thermally plasticizable at a first temperature T₁. A second profile part is produced from a material that is not thermally plasticizable at the first temperature T₁, for example from metal.

These profile parts are connected to one another in their longitudinal direction according to the method in accordance with the invention, wherein the achieved positive engagement or form fit perpendicular to the longitudinal direction can also be configured to be shear-resistant in the longitudinal direction if necessary.

The method in accordance with the invention enables not only an economical production of the composite profile, but also ensures a high level of process security that the conventional roll-in method lacks.

Thus, with the method in accordance with the invention, longer composite profiles can be obtained, for example composite profiles with a length of at least 50 cm or preferably with a length of at least 3 meters. Commercially available composite profiles for metal windows/doors/façades typically have lengths of 5 m to 7.5 m, though different lengths are possible.

It is also possible to produce endless composite profiles (i.e. lengths of several hundred meters), which can then be wound on spools instead of in the form of bar-type goods, provided the profile geometry and the materials allow for the required bend radii.

The positive engagement between the first and the second profile part is preferably of continuous configuration, but may also be regularly or irregularly interrupted.

The connection technology in accordance with the invention is suited in particular for the production of composite components for use in the manufacture of vehicles (railway vehicles, land vehicles, watercraft, and aircraft, etc.), as well as in the manufacture of ventilation systems, plant engineering, and device engineering (stiffening profiles, reinforcing profiles, frame profiles etc.).

In the production of composite profiles for window, door, and façade elements, the first profile part is preferably an insulating profile for thermal separation. Such insulating profiles are generally known under the trade name Insulbar® of the company Ensinger GmbH. These insulating profiles can be produced in many versions, i.e. shapes and materials. The plastic profiles are preferably produced from meltable plastics or plastics materials on the basis of thermoplastic polymers, e.g. polyamides, polyesters, polyolefins, vinyl polymers, polyketones, polyether, and mixtures and blends thereof. Elastomers, in particular thermoplastic elastomers, are also suitable.

The method in accordance with the invention makes it possible, in particular, to continuously connect plastic profile parts to metal profile parts, in particular to aluminum profiles. Here, a positively engaging connection or form fit is produced by one or more profile regions of the first (plastic) profile part being brought into contact with a receiving structure of the second (metal) profile part, for example a groove, and then the second plastics material part of the profile region of the first profile part being plasticized in a zone (joining region) delimited in the longitudinal direction and being mechanically deformed, in particular sunk, under exertion of a pressure, wherein the plasticized second plastics material and the receiving structure of the second (metal) profile part form a positive engagement or form fit, such that, after the second plastics material solidifies, a composite profile with a positively engaging connection extending in the longitudinal direction is obtained.

This process may preferably take place in a continuous manner, i.e., with a continuous longitudinal movement of the profile parts or the composite profile in the process direction (corresponding to the longitudinal direction of the profile).

The connection by positive engagement of material combinations plastic-metal by means of ultrasound is known per se, for example from Saechtling Kunststoff Taschenbuch, 30th Edition from 2007 (ISBN 978-3-446-40352-9), chapter 4.13.1.4 and fig. 4.137F. Here, the method is limited, however, to the introduction of a small metal insert in the form of a threaded bush into a moulded plastic part by application of ultrasound.

DE 32 03 631 A1 mentions the possibility of using an additional material to improve the positive engagement of a metal-plastic composite profile and to press said material into positive engagement-increasing recesses of a receiving groove as part of an ultrasound treatment. However, the prerequisite here is the presence of a connection by positive engagement that is merely improved.

In contrast, in accordance with the invention, a positive engagement as such is produced only through the plasticization and deformation of the second plastics material, such that the method overall can be performed with considerably lower expenditure and lower requirements both for the geometry of the profile region and for the receiving structure. Moreover, the method in accordance with the invention provides a significantly improved freedom of design and, among other things, also with the ability to achieve an improved insulation effect.

In DE 10 2017 107 684 A1 regarding a modular system for plastic profiles, the application of an ultrasonic method for welding plastic components to one another is proposed for producing components with more complex profile cross sections from simple plastic profile shapes. The ability to produce composite profiles with a positively engaging connection of two profile parts is not disclosed.

### DETAILED DESCRIPTION OF THE INVENTION

The plasticization of the second plastics material of the profile region of the first profile part in accordance with the present invention may take place in a variety of ways.

In accordance with one variant of the method in accordance with the invention, the second profile part, in particular a metal profile part, may be preheated or heated to a sufficiently high temperature above temperature T₁ in order to effect the plasticization of the second plastics material of the profile region of the first profile part, i.e., in order to thus deliver the heat energy to plasticize the second plastics material of the profile region of the first profile part (subsequently referred to as the melting region of a plastic profile) to a sufficient degree for the subsequent deformation. In particular contact heating, inductive heating, e.g., by means of guiding the metallic profiles along or through inductive coils, infrared irradiation, or heating by applying a flame to the second profile part etc. are suitable for this.

In accordance with a further preferred variant of the method in accordance with the invention, the plasticization is performed by means of sonication, in particular using a sonotrode. This variant is suitable not only for composite profiles in which the second profile part is a metal component, but also for second profile parts that are made of ceramic materials, glass, wood, a thermoplastic plastics materials with a melting point or a glass transition temperature or optionally softening temperature above the first temperature T₁ and a thermosetting plastics material.

The receiving structure can be configured in a wide variety of ways in the method in accordance with the invention. According to one variant, the second profile part is configured with a receiving region as a receiving structure extending in the longitudinal direction, said receiving region having the form of a receiving groove. In particular, the receiving groove may extend continuously in the longitudinal direction of the second component.

Furthermore, according to the method in accordance with the invention, the second profile part may be configured with a receiving structure which comprises a plurality of recesses that are arranged flush, in particular one behind the other, in the longitudinal direction of the second profile part, which recesses may be, for example surface structurings and/or surface penetrations and/or surface perforations.

In accordance with the invention, the profile region of the first profile part is preferably configured as a projecting profile region, e.g., as a profile region projecting perpendicularly from a surface of the first profile part. The profile region can, in particular, be configured as an uninterrupted, continuous projection extending in the longitudinal direction of the first profile part, or as a plurality of non-continuous projection segments, arranged one behind the other in the longitudinal direction of the first profile part at a distance from one another, optionally formed in alignment with one another.

The first profile part used in the method in accordance with the invention may be equipped not only with one profile region, but with a further profile region that is also made from the second plastics material. The further profile region typically extends in parallel to the first profile region at a predetermined lateral distance perpendicular to the longitudinal direction of the first profile part.

In this variant of the method in accordance with the invention, a third profile part (as a further second profile part) extending in a longitudinal direction, made of a material that is not thermally plasticizable at the first temperature T₁ may be provided, wherein the third profile part has a receiving structure extending in its longitudinal direction. The second or further profile region of the first profile part can then be brought into contact with the receiving region of the third profile part and be plasticized while forming a positive engagement or form fit. This may take place simultaneously with or temporally offset from the first profile region being brought into contact with the receiving region of the second profile part.

The profile region or the profile regions of the first profile part may be produced integrally with the first profile part, for example in one single extrusion operation, wherein, in particular, the first and the second plastics material are then based on the same polymeric material and, in particular, are produced from an identical plastics material.

Alternatively, the profile region(s) may be moulded onto the body, in particular coextruded, extruded on in a subsequent step, welded on, or adhesively bonded on. Here, too, the first and the second plastics material are based on the same polymeric material or are produced from an identical plastics material. Alternatively, different polymeric materials may be used for the production of the profile region(s) on the one hand and the first profile part on the other hand.

This potential variety of materials makes it possible to optimize partial regions of the profiles or the plastic profiles and/or the composite profiles produced therefrom, e.g., with respect to mechanical characteristics (rigidity, strength, impact resistance, elongation at break, dimensional stability, shear strength, shear spring rigidity, creeping tendency etc.), weight, production costs, insulation effect (thermal, electrical, sound etc.), recyclability (material, chemical, thermal), resistance to chemical/physical influences (wind and weather, UV radiation, temperature change, process chemicals, and cleaning agents), paintability (wet paints, powder stoving lacquers, primers), fire protection/flame protection.

In accordance with the invention, in particular flat, band-shaped plastic components can easily be adapted for use as a first profile part in the method in accordance with the invention by the required profile region and optionally further functional elements being connected to said components. The methods suitable for this are known, e.g., extrusion, welding, or adhesive bonding.

Advantages of using long and endless fiber-reinforced composites for producing the first profile part are the superior material properties, especially the increased inherent rigidity, strength (e.g., under tensile, bending, torsional load), and in special cases the improvement of the fire protection properties as a result of temperature-resistant fiber woven fabrics in the profile body.

As already mentioned, according to the method in accordance with the invention, the material that is not thermally plasticizable at the first temperature T₁ can be selected from a wide range of materials. This applies not only to the second, but optionally also to the third profile part. In particular, the material that is not thermally plasticizable at the first temperature T₁ is selected from a metallic material, in particular based on aluminum or iron, a ceramic material, glass, wood, a thermoplastic material with a melting point or a glass transition temperature above the first temperature T₁ and a thermosetting plastics material.

The second profile parts, in particular in the form of metal profiles, of the composite profiles produced in accordance with the invention may also be produced in different geometries and have simple geometric basic forms in cross section (e.g., substantially round, oval, rectangular, square) or more complicated symmetrical or asymmetrical cross sections and optionally different wall thicknesses. For example, an additional structuring may also be provided along the longitudinal direction, for example a periodic or random arrangement of perforations or recesses, or accumulations of material, or deformations, for example by means of knurling, drilling, punching, embossing, or other chemical or physical structuring methods (removal by etching processes or laser treatment).

For example profiles made of rolled stainless steel or extruded profiles of aluminum or aluminum alloys are preferable as second and optionally third profile parts. These profiles are producible in different designs and are commercially available.

Furthermore, in the method in accordance with the invention, the first plastics material for the first profile part and/or the thermally plasticizable second plastics material for the profile region(s) of the first profile part is preferably selected from thermoplastic polymeric materials on the basis of polyamides, polyimides, polyesters, polyolefins, in particular polyethylene and polypropylene, polyketones, vinyl polymers, in particular polystyrene and polyvinylchloride, polyether, in particular polyphenylene ether, polycarbonate, polyphenylene sulfide, and mixtures thereof, in particular polyetherketones, polyetheretherketones, and polyetherimides, as well as copolymers thereof and blends of the above plastics materials. Elastomers, in particular thermoplastic elastomers, are also suitable as the first plastics material.

Overall, the method in accordance with the invention allows for a wide range of materials for the production of the profile parts from a multitude of materials, such that the selection can be tailored specifically to the requirements of the respective application area of the produced composite profiles.

Moreover, in accordance with the invention the first and/or the second plastics material may contain fillers and/or reinforcing substances, which in particular are selected from glass fibers, metal fibers, carbon fibers, plastic fibers, mineral fibers, plant fibers, and mixtures thereof, wherein the fibers are preferably used in the form of short fibers, long fibers, endless fibers, woven fiber fabrics, laid fiber fabrics, or fiber felts.

Further suitable fillers are, e.g., glassy, amorphous, crystalline additives in the form of powders, balls, hollow balls, aggregates, or agglomerates, in particular of glass powder, glass balls, lime, chalk, metal oxides, metal hydroxides, molecular sieves.

Moreover, additives like, for example, flame protection/fire protection agents, thermal/heat/UV/hydrolysis stabilizers, softeners, impact modifiers, expanding agents, glidants and lubricants, colorants, nucleating agents etc. can be used as fillers.

The use of melting adhesives, melting wires (monofilament and coextruded variants), metal wires, foams (cut or extruded foam blocks, foam bands etc.), metal foils (coated or uncoated foils with a single-layer or multi-layer structure) is also possible to be able to functionalize products in a tailor-made manner.

This enables an additional adaptation of the materials used to the requirements of the respective area of application of the composite profiles produced in accordance with the invention.

Particularly preferably are plastic profiles on the basis of polyamide 66 (PA 66), polyamide 6 (PA6), polymer blends of PA66 and polyphenylene ether (PPE), polyethylene terephthalate (PET), polybutylene terephthalate (PBT), acrylonitrile butadiene styrene copolymers (ABS), acrylonitrile styrene acrylate copolymers (ASA), acrylonitrile styrene copolymers (SAN), polyacrylate, for example polymethylmethacrylate (PMMA), polyvinylchloride (PVC), polypropylene (PP), polycarbonate (PC), or polystyrene (PS) with a proportion of glass fibers for reinforcement.

In accordance with a further variant of the method in accordance with the invention, the first profile part is configured to be porous at least in parts, i.e., foamed or filled with porous (porous with open or closed cells) fillers. This increases the heat transfer resistance in the composite profiles and reduces their density. The first profile part may also be configured to be porous as a whole.

The method in accordance with the invention can be performed such that the method steps of bringing the profile region(s) of the first profile part into contact with the receiving structure(s) of the second an optionally the third profile part, the plasticization and the deformation in a zone (joining region) delimited in the longitudinal direction of the profile parts are performed continuously or intermittently. If the first profile part has two profile regions, according to one variant, the bond of the first profile part with the second and the third profile part can thus be produced simultaneously.

The method in accordance with the invention is based on a profile region of the first profile part functioning as a so-called melting element and being plasticized and deformed in contact with a receiving structure of the second profile part, wherein the first and the second profile part are connected to one another by means of a positive engagement or form fit after the second plastics material has solidified.

The plasticization is preferably achieved by introducing ultrasonic vibrations or other high-frequency energy (“high-frequency welding”), or the input of the required amount of heat for plasticizing the profile region (melting element) can also be effected by inductively heating the second profile part. Further, the energy input by means of contact heating with heating elements, heating with open flames, fan heaters or heated gas, infrared radiation, laser radiation is also possible for achieving the plasticization of the second plastics material.

The method in accordance with the invention for producing the composite profile in accordance with the invention is thereby typically carried out such that the first and second profile parts are fed to a joining system and in an intake region of the joining system are oriented relative to one another (setting) in such a way that the respective melting element of the first profile part comes into contact with the associated receiving structure of the second profile part.

The first and second profile parts can be set in this way by, for example, one profile part being inserted or drawn into the other profile part, as is known from the so-called roll-in method. The receiving structure is hereby typically of groove-shaped configuration.

It is also possible, however, to place the one profile part onto the other profile part like a lid. The setting can thereby be facilitated by centering and assembly aids. Functional elements on the part of the first profile part in the form of latching devices, for example snapping hooks, may thereby serve as assembly aids in order to quickly and securely position the initially loosely joined profile parts and make a workpiece able to be handled until the positive engagement is complete. Centering aids on the part of the first profile part as a further functional element can thereby aid in a precise positioning of the profile parts during setting and ensure a correct end position is reached after the formation of the positive engagement.

After the positioning, the first and second profile parts are now transported in their longitudinal direction, which corresponds to the longitudinal direction of the composite profile to be produced, subsequently also called the Z-direction, to a zone (joining region) delimited in the longitudinal direction, said zone being composed of a plasticization section and a holding section following in the Z-direction.

In the plasticization section, according to a preferred embodiment of the method in accordance with the invention, the profile parts are continuously guided in the Z-direction past a sonotrode segment.

In the sonotrode segment, in addition to the sonication, a mechanical pressure perpendicular to the Z-direction is exerted on the two profile parts by way of a contact surface of one or more sonotrodes that abut against a surface of one of the profile parts. A counter bearing must therefore be arranged on the side opposite the sonotrode(s) in order to absorb these forces. The mechanical pressure is thereby preferably produced by the one or more sonotrodes by the contact surfaces thereof being arranged at an angle α relative to the feed direction Z, corresponding to a conveying direction F.

An additional mechanical pressure or contact pressure, in addition to the pressure exerted by the sonotrodes, may be introduced to the two profile parts by additional means, for example by way of pressing rollers, belt drives, spring elements, and/or pressing rails. The speed at which a melting region is then melted off and the profile parts to be joined are brought into their end configuration perpendicular to the Z-direction then arises from the feed speed in the Z-direction and the angle α.

If the contact surface is formed with different angles in one or more sonotrodes, one can, for example, define an average angle α over an entire sonotrode segment, said angle being calculated from the length, measured from the point at the level of the first sonotrode contact, until the final lowering height and the lowering height realized therein is reached. The lowering level is thereby the distance by which the first profile part is melted down or lowered after being brought into contact by the plasticization (of the melting element) and lowering into the end configuration relative to the second profile part.

In accordance with the invention, lowering levels of about 0.3 mm to about 12.0 mm are preferred, lowering levels of about 0.5 mm to about 6.5 mm being particularly preferable.

The joining method may thereby in particular be performed such that a plurality of sonotrode segments are simultaneously in operation to produce a plurality of (offset) positive engagements in one pass. Thus, for example, a first profile part with two profile regions arranged in parallel at a distance from one another, said profile regions forming melting zones, can be connected to two second profile parts simultaneously by way of a respective positive engagement.

In principle, a sonotrode segment may comprise one single sonotrode or a plurality of sonotrodes controlled jointly or separately and lined up in the longitudinal direction Z. The sonotrodes are configured with respect to the arrangement, alignment/tilt, dimensioning, material selection, and power input such that a predetermined melting of the melting element takes place when the profile parts pass through the plasticization section.

The sonotrodes introduce high-frequency ultrasonic vibrations into the profile parts that are to be connected with a positive engagement. The frequency is preferably in the range of about 16 kHz to about 90 kHz, the frequency range is particularly preferably from about 19 kHz to about 45 kHz.

The sonotrodes are preferably installed statically, i.e., during plasticization, after this process, substantially no further movement on the part of the sonotrodes, in particular no raising and lowering movement, takes place, aside from the ultrasonic oscillation. However, it may also be advantageous to use a non-static sonotrode in the method, wherein the contact surface of the sonotrode can then be moved, e.g., both in the longitudinal direction Z and in a height direction Y perpendicular to the longitudinal direction Z. The ability to variably position the sonotrode contact surfaces may also be used to quickly perform adaptations on the part of the plasticization assembly when switching the product geometry to be produced.

The use of so-called co-traveling stamping-motion sonotrodes and so-called rolling sonotrodes is also possible. However, static sonotrodes with a dragging contact to one of the profile parts are preferably used in the method in accordance with the invention (dragging sonotrode).

Performing a continuous through-feed method avoids, in particular, the problem of offset points, which arise, e.g., in a cycled advancing method with cyclically moved sonotrodes or cyclically moved presses.

The sonotrode(s) is/are placed in the required position relative to the profile parts either with a defined pressing force (force control) with a certain contour or a certain location (“travel to end stop”, path control).

The sonotrode is thereby in contact with the components to be joined substantially perpendicularly in relation to the cross section so that the energy (ultrasonic oscillations) can be ideally introduced and mechanical forces that arise can be directly dissipated. It may be the case that, due to geometric restrictions on the part of the profile parts, a perpendicular placement of the sonotrode(s) is not possible, and in this case angled sonotrodes or sonotrodes with angled contact surfaces or with contoured contact surfaces may be used, wherein the contact surface of the sonotrode in cross section perpendicular to the transport direction should have a contour that matches the profile surface.

The sonotrodes, specifically the dragging sonotrodes, are preferably made of metallic materials that are resistant to frictional wear (e.g., hard or hardened steel, titanium, and corresponding hard alloys) or are equipped with coatings on the contact surface that are resistant to frictional wear. Such wear-resistant coatings may be, among other things, typical hard coatings from PVD/CVD (physical/chemical vapor deposition) processes or hardened wet-chemical coatings (e.g. ceramic coatings). In tool making, such methods and coatings are sufficiently known and available. Carbon-based coatings, e.g., so-called diamond-like carbon coatings, as well as oxide, nitride, or carbide coatings are particularly preferable.

The sonotrodes may be operated continuously or in short intervals, for example in fractions of a second, pulsed, or in longer cycles of a few seconds or minutes. The sonotrodes are preferably, as a rule, continuously in operation during the passage of the profile parts. As a result of the high input of energy, measures must be taken to dissipate excess heat, e.g., cooling the sonotrodes with air, water, or other media, as well as equipping surfaces with coating with a high emissivity to improve the heat dissipation.

The plasticization characteristics of the second plastics material can be controlled by different parameters, among other things the design of the profile geometries of the first profile part (wall thicknesses, profile shapes, design of the melting region) and the associated receiving structure, the lowering level, the sonication depth and other things. The selection of the materials for the profile region of the first profile part (rigidity, E-modulus, melting temperature, softening temperature, glass transition temperature, material densities, loss factors for the respectively introduced energy etc.) and the joining parameters (advance speed, lowering speed, energy input, frequency/amplitude of the ultrasonic sonotrode, preheating the first profile part and/or the second profile part) are important.

The plasticization characteristics of the second plastics material can also be influenced by the second profile part or by the material of the second profile part. For example, easily co-vibrating or resilient profile geometries of the second profile part are disadvantageous for the plasticization characteristics. These disadvantages can be eliminated by constructive features (increasing the wall thicknesses in the region of the receiving structure, supporting the receiving structure by means of force-dissipating webs etc.).

After the plasticization section, a holding section is arranged in which the possibly still hot plasticized mass of the second plastics material of the melting region can cool and solidify in a controlled manner after deformation. In this region of the holding section, the profile parts are held in the desired relative position to one another and optionally are conveyed further in the longitudinal direction. It is also possible to convey the profiles transversely. If necessary, mechanical pressure may thereby also be introduced, for example by means of pressing rollers, cylinders, dragging pressing rails, holding matrices, or chain- or band-driven pressing elements (band withdrawal). The cooling typically happens quickly due to the dissipation of heat by the material of the first and in particular the second profile part, if the latter is produced from a metallic material. If required, excess heat can also be dissipated by cooling, for example by means of air, water, oil, or other media.

After passing through the joining region, the positively engaging connection between the profile parts is formed and the composite profile is transported further into an outlet region where a removal of the profile can take place or, optionally, successive further processing steps (bundling, foiling, packaging, signing, cleaning, pretreating, coating etc.) can take place.

It is also possible to place the sonotrode in contact with the second profile part in order to input energy through the material of the second profile part (for example metal) into the material (second plastics material) of the profile region of the first profile part in such a way that the plasticization of the second plastics material is possible and the formation of a positive engagement is achieved. This is particularly preferable if the material of the second profile part has a higher rigidity than the material of the first profile part, e.g., a rigidity that is twice as high (measurable as E-modulus, e.g., with aluminum or stainless steel) and/or the ultrasound can be guided as rectilinearly as possible from the region of the sound introduction to the receiving structure and/or these sound-conducting profile structure of the second profile part are designed to have thick walls, for example with wall thicknesses of about 2 mm or more.

According to the method in accordance with the invention, the positive engagement(s) is/are preferably produced with a shear strength in the longitudinal direction of the composite profile of about 2 N/mm or more, particularly preferably about 5 N/mm or more. More specifically, the shear strength is at least 2 N/mm, especially at least 5 N/mm. The shear strength of composite profiles (metal profiles with a thermal break) can be determined according to DIN EN 14024:2004.

The method in accordance with the invention makes it possible, in particular in any combination, that the first and/or the second profile part and/or the third profile part are provided as endless material or as bar-type goods.

Further, according to the method in accordance with the invention, the second profile part and/or the third profile part are provided with a receiving structure in the form of a recess which, seen in cross section perpendicular to the longitudinal direction of the composite profile, has an undercut at least in sections.

In addition, according to the method in accordance with the invention, the cross section of the receiving structure of the second profile part and/or the third profile part, seen perpendicular to the longitudinal direction of the composite profile, may vary along the longitudinal direction in its width and/or depth, for example as a result of compression moulding of regions of the second/third profile parts.

The creation of particular cross sectional geometries of the second and/or third profile parts may take place in the process sequence, i.e., before the joining process or in a separate process performed beforehand.

Furthermore, according to the method in accordance with the invention, before the plasticization of the profile region or the profile regions, the first profile part and the second and optionally the third profile part can be positioned by means of a first guidance apparatus in a predetermined, optionally variable relative position to one another and be guided in the longitudinal direction of the composite profile.

In a further variant of the method in accordance with the invention, after the plasticization and deformation of the profile region or the profile regions, the first profile part and the second and optionally the third profile part can be positioned by means of a second guiding device in a predetermined, optionally variable relative position to one another, and be guided in the longitudinal direction in order to, for example, reach, maintain, or optionally correct a predetermined lowering level.

Also, according to the method in accordance with the invention, after the plasticization and deformation of the profile region or the profile regions and upon passing through an optional second guidance apparatus following the plasticization and deformation of the profile region(s), the first profile part and the second and optionally the third profile part can be pressed against one another with a predetermined force and can then be held in the same or in a further predetermined relative position until the plasticized second plastics material has solidified.

According to a further variant of the method in accordance with the invention, after the plasticization and deformation of the profile region or the profile regions and upon passing through an optional second guidance apparatus following the plasticization and deformation of the profile region(s), the first profile part and the second and optionally the third profile part can be pressed against one another in a predetermined relative position and can then be held in the same or in a further predetermined relative position until the plasticized second plastics material has solidified.

According to the method in accordance with the invention, the profile region or the profile regions of the first profile part is/are preferably configured as a projection or as projections, which extends/extend away from a surface of the first profile part by about 10 mm or less, preferably about 6 mm or less. More specifically, the projection or projections extend away from a surface of the first profile part by at most 10 mm, preferably at most 6 mm. A sufficiently large mass of the second plastics material can thus be made available in order to be able to produce positive engagements for the absorption of large forces (tensile, shear, bending etc.). Shorter projections are also preferred, because they can be better sonicated and thus the plasticization is easier to achieve.

In the method in accordance with the invention, the first profile part and the second profile part, optionally together with the third profile part, are preferably guided toward one another at an acute angle with respect to the longitudinal direction of the composite profile, wherein the guidance extends at an acute angle at least over partial regions of the zone of plasticization and deformation and optionally in the first and/or second guidance apparatus.

Further, in the method in accordance with the invention, the plasticization is performed by means of sonication, preferably in the so-called near-field method, wherein a sonotrode thereby has a direct contact to one of the profile parts. A distance of the contact surface of the sonotrode from the respective other profile part is thereby preferably about 10 mm or less, further preferably about 6 mm or less. More specifically, the distance of the contact surface of the sonotrode from the respective other profile part is at most 10 mm, preferably at most 6 mm.

In preferred methods in accordance with the invention, the zone for the plasticization, measured in the longitudinal direction of the composite profile, has a length of about 5 cm to about 100 cm, preferably a length of about 5 cm to about 50 cm, wherein optionally an ultrasound unit with one or more sonotrodes is used for the plasticization.

It is further preferable in the method in accordance with the invention that the contact surface(s) of the sonotrode(s) in the zone of plasticization and deformation, in relation to the longitudinal direction of the profile part(s) in contact with the sonotrode(s), is/are at a distance from a surface of the other profile part(s) of the composite profile, said distance decreasing along the longitudinal direction of the composite profile seen in the passage direction (lowering level).

The contact surface(s) is/are thereby arranged in an angular position or in different angular positions, wherein the angular positions may vary continuously and/or in steps.

In the method in accordance with the invention, the sonotrode to be used in the zone of plasticization and deformation is preferably selected as a static sonotrode, which is configured, in particular, as a dragging sonotrode. That means that a profile part is dragged along the contact surface of the stationary or standing sonotrode, while the sonotrode oscillates at an ultrasonic frequency.

In the method in accordance with the invention, the produced composite profile, seen in the longitudinal direction of the composite profile, is conveyed at a speed of about 3 m/min or more, in particular about 10 m/min or more. More specifically, the conveying speed is at least 3 m/min, preferably at least 10 m/min.

In the method in accordance with the invention, the dwell time of the profile parts in the zone of plasticization and deformation is preferably about 0.1 sec to about 10 sec, further preferably about 0.2 sec to about 5 sec.

In the method in accordance with the invention, the sonotrode is preferably operated continuously.

The present invention further relates to a composite profile, produced according to the method in accordance with the invention.

In the composite profile in accordance with the invention, the first profile part has, in particular, one or more functional elements. By means of the functional elements, the composite profiles can be easily adapted to a multitude of requirements and tasks.

The composite profile in accordance with the invention will often comprise a second profile part, which has a visible side surface on which the receiving structure is formed.

The first profile part, after the formation of the positive engagement, may then be arranged with a surface region flush with the visible side surface.

In preferred composite profiles in accordance with the invention, the first profile part, after the formation of the positive engagement, substantially completely covers the region of the second profile part at which the receiving structure is formed.

Particularly appealing visible surfaces of composite profiles can thereby be achieved. In comparison to conventional roll-in profiles, in preferred embodiments, there are hardly any or no direct indications of the connecting structure/geometry hidden beneath when viewed from the outside.

Preferred composite profiles in accordance with the invention have a visible side surface, which is formed by the visible side surface of the second profile part, a surface region of the first profile part arranged flush with the visible side surface of the second profile part, and optionally a visible side surface of a third profile part, wherein the visible side surface of the third profile part is preferably arranged flush with the surface region of the first profile part.

The profile parts used, assuming they are provided as plastic profiles, are preferably produced in an extrusion process. In addition, pressed, calendered, pultruded, or other strand-shaped profile parts produced in a different manner may be used. Fabric reinforced or endless fiber reinforced thermoplastic composite materials, so-called prepregs, organic tapes, organic sheets, or in general composites in long sheets or strips are particularly preferable. These materials may be different in composition and geometry or can be easily formed to desired geometries of the respective profile part (“thermoforming”). Further components may be subsequently attached or moulded on as required.

The profile parts used in the method in accordance with the invention may, unlike typical roll-in profiles from the prior art, have other forms, which in particular have better mechanical and also better optical properties. The composite profiles formed may also have new cross sectional geometries that were previously inaccessible.

While linear composite profiles are desired or required in many areas of application, in some applications, a design of bent or twisted composite profile geometries may be desired or required. An adaptation of the method in accordance with the invention makes it possible to set appropriate bend radii (to produce composite profiles bent in the longitudinal direction or, in the extreme case, shaped into rings or spirals), or twist angles or torsion angles (to produce composite profiles twisted in the longitudinal direction in the shape of a screw).

The composite profiles are preferably designed such that the lowering level is low, for example smaller than about 10 mm, preferably smaller than about 6 mm, further preferably smaller than about 3 mm.

Likewise, in composite profiles in accordance with the invention, the profile parts are preferably constructed such that the distance between the potential contact surface of the sonotrode with the first profile part and the remote end of the associated profile region (melting region) of the first profile part is small (small sonication depth), namely preferably smaller than about 20 mm, further preferably smaller than about 10 mm, most preferably smaller than about 6 mm.

The first profile part, in particular in the form of an insulating profile, may itself be configured in different forms and have, in addition to the profile regions made of the second plastics material (melting regions), a multitude of further functional zones or functional elements, which are known from the prior art for the respective target application, for example flags and/or hollow chambers for reducing convection, screw channels, grooves, hooks, for example for accommodating seals or metallic elements, stops in the form of noses, arrows, centering and assembly aids, special projections for accommodating transverse tensile forces and so on.

The profile regions of the first profile part (melting regions) may also be configured in different forms. Symmetrical or asymmetrical cross sections with at least one taper, for example pointed, rounded forms with one or more points or terminal rounded portions, are preferred. Blunt melting regions may also be used. It is also possible to introduce a taper, for example in the form of a waisting, into a melting region. The taper hereby has the purpose of concentrating the ultrasonic energy and predetermining a region in which the plasticization operation begins, wherein this region is then located within the melting element and thereby initially has no contact with the receiving structure or the material of the receiving structure (until the deformation).

Associated with a melting region of the first profile part, a respective receiving structure is provided on the part of the second profile parts. Said receiving structure accommodates the melting region of the first profile part and provides a volume for the plasticized second plastics material of the melting region. The receiving structure is also configured in such a way that a connection by positive engagement becomes possible, for example by means of undercut regions.

The receiving structure is preferably configured as a continuous groove with an undercut, such that a sort of receiving volume extending in the longitudinal direction arises in the cross section perpendicular to the longitudinal direction of the composite profile. This groove may be both symmetrical and asymmetrical in cross section perpendicular to the longitudinal direction and, for example, taper or widen in cross section. This groove may also contain an element tapering toward the groove opening, for example in the form of a triangular cross-section, which element can then function as a so-called energy director in the ultrasonic welding process and both concentrates the ultrasonic energy in the tip and simultaneously diverts the plasticized mass along the flank of the triangle.

The groove is configured with respect to its cross sectional geometry in such a way that it can completely accommodate the resulting melting volume of the profile region (melting element) of the first profile part. The volume provided by the groove may optionally be formed somewhat larger than the resulting melting volume. A buffer may thereby be advantageous to compensate for a possible deviation of the melting volume, which deviations may result from geometric variations, fluctuations in the plasticization process etc.

The groove itself may also be configured such that the profile region (melting region) centers itself.

In a further variant of the method in accordance with the invention, a composite profile may be produced with very good profile statics from two profiles of the type of the first profile part and two profiles of the type of the second profile part by the two first profile parts, in addition to the connection by positive engagement of the first and second profile parts, being joined by substance-to-substance bond (e.g. adhesive bonding or welding). This process may also be combined in a direct process sequence with the production of the positive engagement or form fit.

An adhesive, for example a melting adhesive or a melting wire with melting adhesive content, may preferably be applied in the receiving structure and/or on or at the melting region.

A separate adhesive does not necessarily have to be introduced in the region of the receiving structure, but rather may also be applied in the adjacent regions, wherein the adhesive should have contact with the first and the second profile part. Adhesives of that kind may then optionally be thermally activated only in a later process step (e.g., by means of powder paint baking).

Composite profiles produced in accordance with the invention thereby have a multitude of advantages:

Composite profiles in accordance with the invention can be produced without knurling an aluminum profile. Alternative possibilities for increasing the strength and in particular the shear strength can be achieved—if necessary—by optimizing the geometry of the receiving structure, and additional use of (melting) adhesives, the use of friction-increasing means (sharp-edged particles, e.g., sand, corundum etc.) in the positive engagement region.

Composite profiles in accordance with the invention achieve a better heat insulation without having to vary the main dimensions, in particular the installation depth L_{b} of the composite profile. An increase of the so-called insulation depth Lᵢ improves the so-called U_{f} values. Composite profiles in accordance with the invention with a cross section of smaller dimensions can be achieved while maintaining the same U_{f} values.

The freedom of design in composite profiles in accordance with the invention is significantly increased, and in particular composite profiles with smooth visible surfaces can be achieved. The striking and unpleasant positioning of the knurling marks in visible regions, as is required in some cases in the roll-in method, can be avoided.

Common functional elements like, for example, flags, hollow chambers, noses, hooks, stops, grooves etc., can easily be integrated into the structure of the composite profiles in accordance with the invention. The combinability with known production steps, e.g., foiling with metallized or metallic foils, the attachment of foams, e.g., adhesively bonded plastic foams (PE, PP, PET, PS, PA, PU etc.) or reactive insulating foams (PUR), cover films or anti-scratch films and so on, is also possible.

Relevant characteristic data of the bond can be improved: The shear strength can be increased by means of the good positive engagement. The transverse tensile strength of the composite profiles can be increased, because, for example, smaller or no chamfer angles have to be constructively integrated into the first profile parts designed as insulating profiles.

The torsional rigidity can be improved because first profile parts, in the form of insulating profiles, abutting on the outside against the second profile parts increase the geometrical moment of inertia.

Undercuts in metal profiles that are used as a second profile can be of a more solid configuration because a roll-in hammer that has to be deformable in a cold state is not required. More solid connections can thus be achieved.

The function of the formation of a positive engagement can be decoupled from further mechanical functions to be considered, for example the absorption of transverse tensile forces. As a result, the different functions of the composite profile can be optimized more simply and at least partially independently of one another.

A simplified production of the aluminum extruded profiles is conceivable, because simpler cross sections are possible (relatively thin-walled and complicated structures in the region of the roll-in geometry (hammer and anvil)).

The process of forming the positive engagement or form fit is thereby better controllable and the proportion of rejects is reduced.

The positive engagement can be produced with high production speeds.

A warp-free connection of the profiles is possible because there is no cold deformation of the metal.

The tightness of the connection zone of the first and second profile part is improved and thus an increase in the driving rain water tightness can be achieved.

Because the insulating profiles no longer necessarily have to be inserted in the longitudinal direction into the metal profiles, but instead can be placed like a lid, the accessibility to a cavity in the composite profile is simple and is possible over the entire profile length. As a result, for example additional product components can be more easily introduced into the cavity, for example in order to improve fire protection, sound insulation, the thermal insulation properties, or the profile statics. This includes, among other things, the insertion of foam strips, insulating material, reinforcing struts or profiles, clips made of metals or plastics materials, the introduction of reactive foam masses etc.

By means of the welding process, not only can the plastic profile (first profile part) be fixedly connected to the aluminum profile (second profile part), but also optionally a plurality of plastic profiles with one another. Thus, transversely braced profiles with improved statics of the composite profile can be produced in the same manufacturing process.

The use of flat, tape-shaped composite materials like e.g. so-called organic tapes or organic sheets in the form of strips is possible as an alternative starting material for plastic profiles (first profile parts). This opens the way to more effective composite profiles. The necessary profile regions can be simply applied to these flat materials, for example retroactively by corresponding shaping or by moulding (injection molding, welding etc.) functional zones made of compatible plastics materials.

The plastic profiles (first profile parts) in composite profiles in accordance with the invention can be larger (compared with traditional roll-in composite profiles) with the size of the cross section of the composite profile remaining the same, and thus a greater insulation depth can be achieved. Likewise, the composite profiles in accordance with the invention can be configured with a smaller cross section than in corresponding roll-in composite profiles with the same insulation depth. More intricate and/or better insulating window/door/facade systems can thus be built.

Composite profiles produced in accordance with the invention can be easily recognized by a test sample being taken from a longer composite profile and further relevant features can be confirmed. By means of an optical or, better, a microscopic analysis of suitable cuts, a person skilled in the art can trace the emergence of the positively engaging connection back to the plasticization of the plastics material. Cross sections can be made either with a cleanly performed saw cut or, better, as a micrograph of test samples embedded in resin. A person skilled in the art for joining technology will be able to associate further characteristic features with the method.

These and further advantages of the invention will be explained in more detail in the following in the context with the drawings.

### BRIEF DESCRIPTION OF THE SEVERAL VIEWS OF THE DRAWINGS

FIG. 1 shows a conventional composite profile with profile parts to be connected in the roll-in method;

FIG. 2A shows a first profile part to be used in accordance with the invention;

FIG. 2B shows two first profile parts of FIG. 2A positioned between two further second profile parts, schematically depicted in an apparatus for connecting by positive engagement;

FIG. 2C shows a completed composite profile in accordance with the invention;

FIG. 3A shows a first profile part to be used in accordance with the invention;

FIG. 3B shows the first profile part of FIG. 3A positioned in combination with two further second profile parts, schematically depicted in an apparatus for connecting by positive engagement;

FIG. 3C shows a completed composite profile in accordance with the invention;

FIGS. 4A to 4D show a sequence of the bringing together and the forming of the positive engagement corresponding to the present invention with a composite profile according to FIG. 5A;

FIG. 5A shows a composite profile in accordance with the invention with a further variant of the positive engagement between the first and second profile parts;

FIGS. 5B and 5C show an enlarged section from FIG. 5A before and after formation of a positive engagement, respectively;

FIG. 5D shows a light microscope image of a saw cut of a positive engagement, produced in accordance with the invention, of a composite profile according to FIG. 5A;

FIG. 6 shows a further variant of a composite profile in accordance with the invention;

FIGS. 7A to 7C show different variants of a first profile part for producing a composite profile in accordance with the invention;

FIG. 8 shows a further variant of a composite profile in accordance with the invention;

FIGS. 9A to 9D show different stages in the production of a composite profile, in accordance with the invention, according to a further variant;

FIGS. 10A to 10H show first profile parts for a composite profile in accordance with the invention as well as the profile regions thereof in multiple variations;

FIG. 11A shows a further variant of a first profile part for producing a composite profile;

FIGS. 11B and 11C show different stages of the production of a composite profile when using a first profile part according to FIG. 11A;

FIGS. 12A to 12G show a second profile part with a receiving structure in multiple variations;

FIGS. 13A to 13C show further variations of receiving structures of second profile parts in accordance with the present invention;

FIGS. 13D to 13F show a further variation of a receiving structure in different views;

FIG. 14 shows a first variant of an apparatus for producing a composite profile in accordance with the invention;

FIGS. 15A and 15B show two further variants of an apparatus for producing a composite profile in accordance with the invention;

FIG. 16 shows a further variant of an apparatus for producing a composite profile in accordance with the invention;

FIG. 17 shows a further variant of an apparatus for producing a composite profile in accordance with the invention;

FIGS. 18A and 18B show a further variant of an apparatus for producing a composite profile in accordance with the invention in a three-dimensional depiction and in plan view; and

FIGS. 19A to 19D show a further variant of a composite profile in accordance with the invention with modified receiving structures as shown in detail in FIGS. 19B and 19D.

### DETAILED DESCRIPTION OF THE DRAWINGS

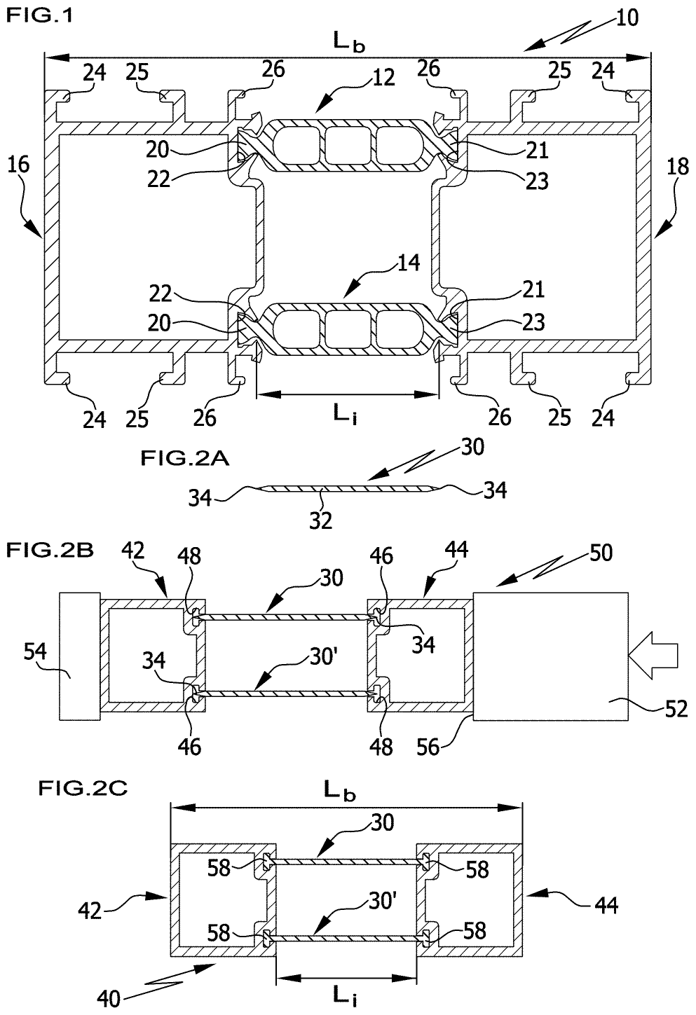

FIG. 1 shows in cross section a conventional composite profile 10, as is used in particular in the production of window and door frames.

The composite profile 10 has two plastic profiles 12, 14, which are arranged between two metal profiles 16, 18 and hold same at a predetermined distance Lᵢ (insulation depth). The width (installation depth) of the composite profile 10 is designated in FIG. 1 with the symbol L_{b}. The distance Lᵢ is hereby determined starting from the last point of contact of the more highly thermally conductive material (in this case metal) and the heat-insulating material (in this case plastic).

The two plastic profiles 12, 14 are configured as hollow chamber profiles and have on their opposite sides so-called roll-in heads 20, 21, which are introduced into corresponding complementary roll-in grooves 22, 23 of the metal profiles 16, 18.

The metal profiles 16, 18 have projections 24, 25, and 26 angled toward one another in pairs, which form a receptacle for further components, for example sealing elements or locking bars.

FIG. 2A shows in cross section a first profile part 30 to be used in accordance with the invention having a web-shaped base body 32, which extends in a longitudinal direction Z (not depicted) and which has on both sides of the base body 32 a first and a second profile region 34, respectively.

In the present embodiment, the first profile part 30 in its totality, i.e., its base body and the profile regions 34 moulded thereon, are produced from one plastics material, i.e, in this embodiment the first and second plastics materials are identical and are produced in one single extrusion process.

FIGS. 2B and 2C show the use of the first profile part 30, 30′ in the production of a composite profile 40 in accordance with the invention, which, in addition to two first profile parts 30, 30′, comprises two second profile parts 42, 44, which are typically configured as metal profiles.

The metal profiles 42, 44 are configured as hollow profiles and have on one side receiving structures in the form of receiving grooves 46, 48, which have a T-shaped cross section seen perpendicular to the longitudinal direction Z of the profiles, said cross section providing a volume in which the plastics material of the profile regions 34 can be accommodated upon the formation of a positive engagement in accordance with the invention.

In FIG. 2B, the two first and the two second profile parts 30, 30′ and 42, 44, respectively, are arranged in a schematically depicted ultrasonic welding apparatus 50, which has a sonotrode 52 for one and a counter bearing 54 for another. The profile parts 30, 30′, 42 and 44 already oriented and placed in the structure of the composite profile to be produced are arranged between the sonotrode 52 and the counter bearing 54, such that the second profile part 42 abuts directly on the counter bearing 54, while the other second profile part 44 abuts on a contact surface 56 of the sonotrode 52.

The four components of the composite profile 40 to be produced can, as a whole as depicted in FIG. 2B, be continuously fed in the ultrasonic welding apparatus 50 in the region between the sonotrode 52 and the counter bearing 54, wherein ultrasound is transmitted by the sonotrode 52 to the second profile part 44, with the energy of which the profile regions 34 of the two first profile parts 30, 30′ are first plasticized and then deformed by the effect of pressure, such that the second plasticized plastics material of the profile regions 34 penetrates into the receiving grooves 46, 48, deforms there, and forms a respective T-shaped positive engagement 58. As soon as the second plastics material of the profile regions 34 has cooled after the plasticization, deformation, and filling of the grooves 46, 48, a solid bond of the profile parts 30, 30′, 42 and 44 is achieved, as is depicted in FIG. 2C.

Compared to the embodiment of FIG. 1, it is clear here that the receiving structure on the part of the second profile parts 42, 44 can be designed significantly more simply and, moreover, as described in more detail in the following and shown with further embodiments, offers a wide range of design options for the connection region of the composite profile in accordance with the invention.

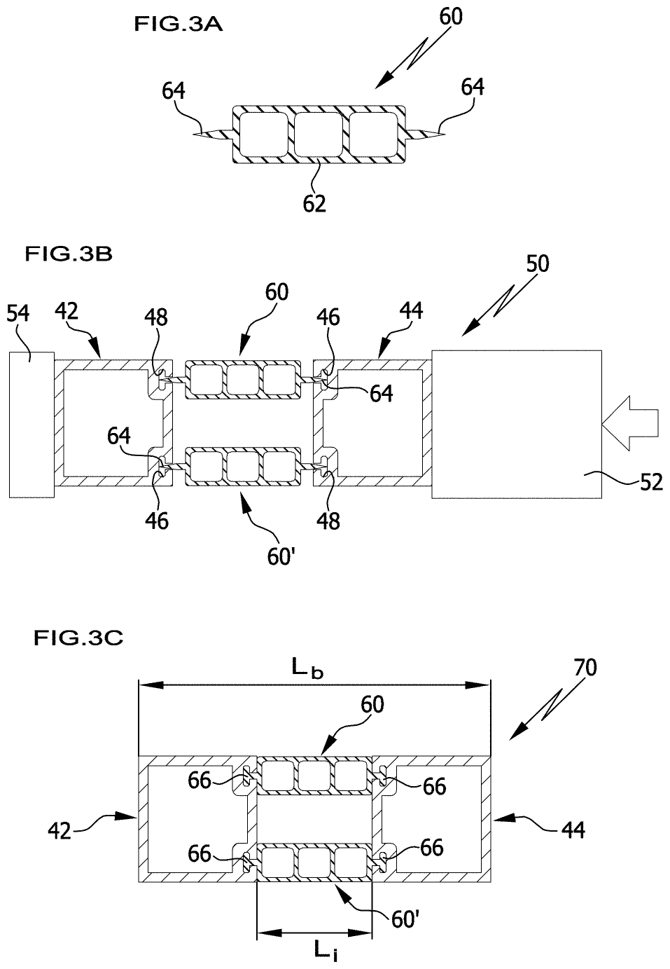

FIG. 3A shows in cross section a first profile part 60 to be used in accordance with the invention having a base body 62, which extends in a longitudinal direction Z (not depicted) and which has on both sides of the base body 62 a first and a second profile region 64, respectively. The profile part 60 is configured as a hollow chamber profile, similar to the profile part 12 of the composite profile 10 in FIG. 1.

In the present embodiment, too, the first profile part 60 in its totality, i.e., its base body 62 and the profile regions 64 moulded thereon, are produced from one plastics material, i.e., in this embodiment the first and second plastics materials are identical.

FIGS. 3B and 3C show the use of the first profile part 60, 60′ in the production of a composite profile 70 in accordance with the invention, which, in addition to two first profile parts 60, 60′, comprises two second profile parts 42, 44 that were already described in the context of the embodiment in FIG. 2.

In FIG. 3B, the two first and the two second profile parts 60, 60′ and 42, 44, respectively, are arranged in the ultrasonic welding apparatus 50, again depicted schematically. The profile parts 60, 60′, 42 and 44 already oriented and placed in the structure of the composite profile 70 to be produced are arranged between the sonotrode 52 and the counter bearing 54, such that the second profile part 42 abuts directly on the counter bearing 54, while the other second profile part 44 abuts on the contact surface 56 of the sonotrode 52.

The four components of the composite profile 70 to be produced can be fed as a whole, as shown in FIG. 3B, in the ultrasonic welding apparatus 50 in the region between the sonotrode 52 and the counter bearing 54, wherein ultrasound is transmitted by the sonotrode 52 to the second profile part 44, with the energy of which the profile regions 64 of the two first profile parts 60, 60′ are first plasticized and then deformed by the effect of pressure, such that the second, plasticized plastics material of the profile regions 64 penetrates into the receiving grooves 46, 48, deforms there, and forms a respective T-shaped positive engagement or form fit 66. As soon as the second plastics material of the profile regions 64 has cooled after the plasticization, deformation, and filling of the grooves 46, 48, a solid bond of the profile parts 60, 60′, 42 and 44 is achieved, as is depicted in FIG. 3C.

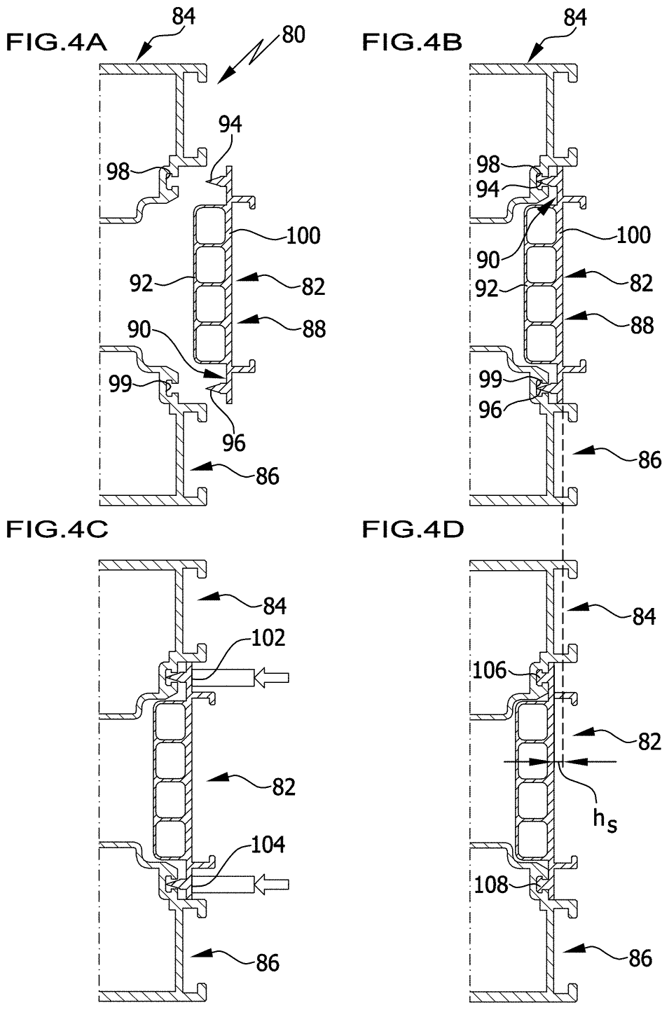

In comparison with the embodiment of FIG. 2, it can be seen that the composite profiles in accordance with the invention also contain complexly structured first profile parts and are not limited to simple structures like that of the first profile part 10. This is visible in particular in the following embodiment in FIG. 4.

FIG. 4A shows in cross section a half of a composite profile 80 in accordance with the invention with a first profile part 82 made of a plastics material, for example a glass fiber-reinforced polyamide material extruded in one piece, and two second profile parts 84, 86 made of metal, for example aluminum, before the positively engaging connection of the profile parts according to the method in accordance with the invention.

The first profile part 82 is configured as a hollow chamber profile, wherein the profile geometry is based on a web-shaped base body 88, onto which a hollow chamber structure 92 with four hollow chambers is moulded on a first surface 90. On both sides of the hollow chamber structure 92, a first and a second profile region 94, 96 extend substantially perpendicularly away from the surface 90 of the base body 88. The two profile regions 94, 96 have at their free ends a substantially triangular cross section.

The second profile parts 84, 86 are arranged on both sides of the first profile part 82 and have on their regions facing toward the first profile part a receiving structure in the form of grooves 98, 99 that are T-shaped in cross section. In the illustration in FIG. 4A, the two metal profiles 84, 86 are already positioned such that the grooves are aligned to the two profile regions 94, 96.

In a next step, the first profile part 82 is, preferably simultaneously, placed on the two second profile parts 84, 86, such that the two profile regions 94, 96 of the first profile part loosely engage in the grooves 98, 99 of the second profile parts 84, 86 and form a physical contact, as is shown in FIG. 4B.

In a subsequent step, a sonotrode is placed with its contact surfaces 102, 104 on the surface 100, opposite the surface 90, of the base body 88 of the first profile part 82, as shown in FIG. 4C, in such a way that the contact surfaces 102, 104 are placed opposite the profile regions 94, 96. By way of the sonotrode and its contact surfaces 102, 104, ultrasonic energy is subsequently introduced into the profile regions 94, 96, said energy being sufficient to plasticize the plastics material of the profile regions 94, 96. By way of the sonotrode, pressure can simultaneously be exerted on the surface 100 of the first profile part 82, such that upon plasticizing the plastics material, same deforms and fills the cavity provided by the grooves 98, 99 and in each case produces a positive engagement or form fit 106, 108 between the first profile part and the second profile parts. This is shown in FIG. 4D.

The lowering level h_{S} that arises in the method in accordance with the invention in the production of the composite profile in accordance with the invention can be seen in the comparison of the positioning of the first profile part 82 with the second profile parts 84, 86 in FIGS. 4B and 4D. In this embodiment, said lowering level is about 2 mm.

In the present embodiment, the first profile part 82 in its totality, i.e., its base body 88 and the profile regions 92, 94, 96 moulded thereon, are produced from the same plastics material, i.e., in this embodiment the first and second plastics materials are identical. The targeted plasticization of the profile regions 94, 96 when acted upon by the ultrasound of the sonotrode results from the form of said profile regions 94, 96. Other portions of the first profile part 82, in particular the base body 88 and the hollow chamber structure 92, retain their original form during the plasticization process, even if they are produced from the identical plastics material as the profile region.

Alternatively, the profile regions 94, 96 may also be produced from a second plastics material, for example extruded onto, coextruded with, welded onto, or adhesively bonded to the base body 88. With this approach, the first and the second plastics material can each be selected substantially independently of one another and optimized for the respective purpose.

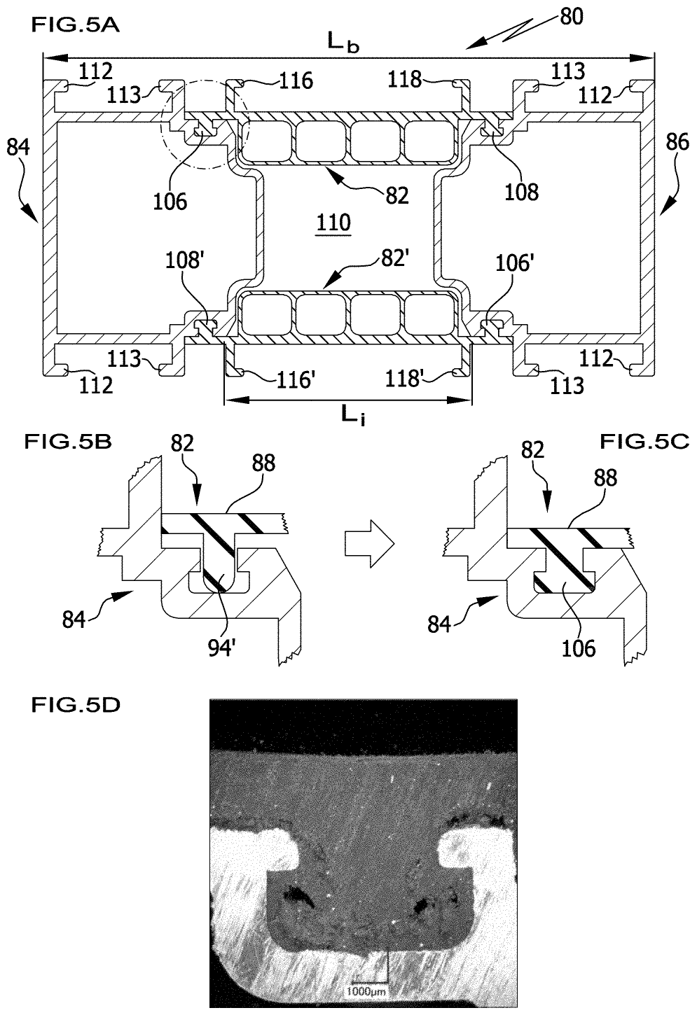

FIG. 5A shows a composite profile 80 produced in accordance with the invention in its entirety, in which the two second profile parts 84, 86 are fixedly connected to one another by way of two first profile parts 82, 82′ by means of the positive engagements 106, 108 and 106′, 108′, respectively, while forming a central hollow chamber.

The second profile parts 84, 86 have projections 112, 113 angled toward one another in pairs, said projections serving to receive further components, for example sealing lips. The first profile parts 82, 82′ also have projections 116, 118 and 116′, 118′, respectively, angled toward one another in pairs, which also can accommodate further components like, e.g., sealing elements or locking bars.

The cross sectional geometry thus corresponds substantially to the cross sectional geometry of the conventional composite profile 10 from FIG. 1, but with a few substantial differences.

This results in a significantly (about +33%) higher insulation depth Lᵢ with the same installation depth L_{b}, wherein the base structure of the two metal components (second profile parts) 84, 86 can be simplified and otherwise remains unchanged. In particular the configuration of the grooves 98, 99 and their surroundings in which, for one, the first profile part 82 can take on a functional element and, for another, the metal component can be designed more simply in the region of the respective groove 98, 99, because a deformability or shapeability of the metal component in the region of the grooves 98, 99 is not required. Moreover, a better appearance on the respective visible sides of the composite profile can be achieved, because, in particular, knurling marks, as shown in the region of the roll-in connections in FIG. 1, can be avoided. Further, a portions of the angled projections (in this case projections 116, 118) may be formed on the first profile part.

FIG. 5B together with FIG. 5C again shows schematically the process of the formation of the positive engagement 106 by means of the deformation of a profile region 94′, which here is shown in a slight variation over the first profile region 94 in FIG. 4A with a rounded tip in place of a triangular free end.

FIG. 5D finally shows a light microscope image of a saw cut of a positive engagement obtained in this way (FIGS. 5B and 5C), and the microstructure of the deformed plastics material achieved in the deformation.

It can be seen in the embodiment of FIG. 5A that due to the different orientation of the profile regions 94, 96 of the first profile parts 82, the bonding to the respective metal profile 84, 86 can take place in steps, i.e. the two first profile parts 82, 82′ can be connected to the respective second profile parts 84, 86 in two successive separate method steps, such that, depending on the complexity of the geometry of the individual profile parts, the bond can be produced in steps or, as is possible in the case of the composite profile 80 in FIG. 5A, simultaneously.

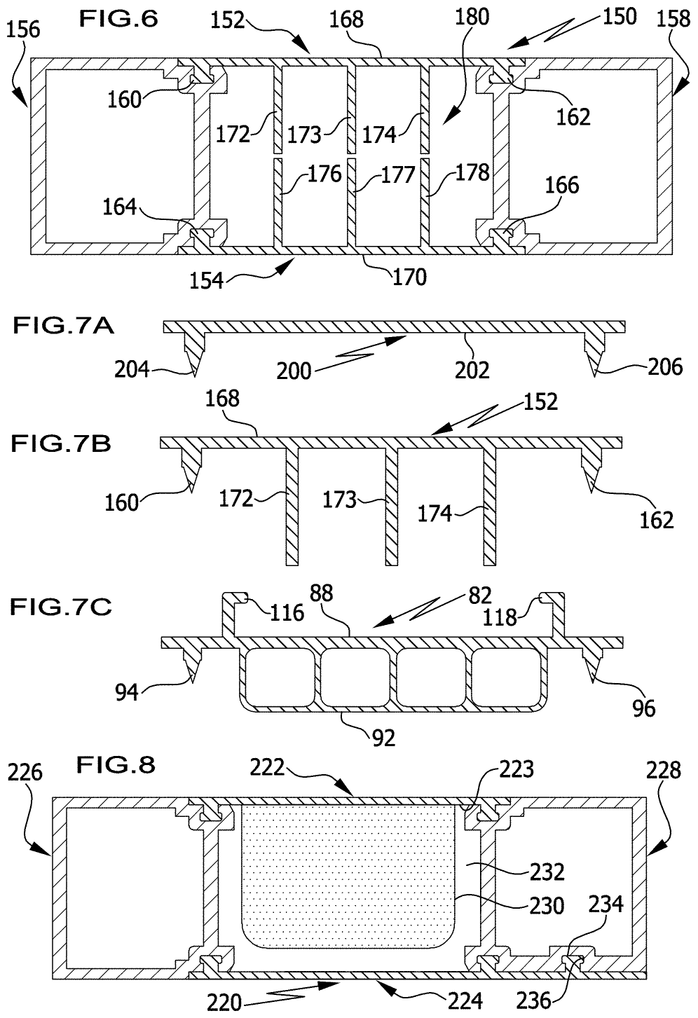

A further embodiment of a composite profile 150 in accordance with the invention can be seen in FIG. 6, in which the composite profile 150 is produced from two first profile parts 152, 154 and two second profile parts 156, 158, typically produced from metal.

Like in the case of the composite profile 80 in FIG. 5A, here, corresponding grooves are formed in the metal profiles (second profile parts) 156, 158 for the profile regions 160, 162 of the one first profile part 152 or the profile regions 164, 166 of the other first profile 154 that form the positive engagement, analogous to the concept as was previously described in conjunction with FIGS. 4A to 4D.

The first profile parts 152, 154 are first profile parts that are produced from a base body 168 and 170, respectively, from which in each case projections 172, 173, 174 and 176, 177, 178, respectively, project perpendicularly (“flags”) at regular intervals in the longitudinal direction of the first profile parts 152, 154, which projections are formed on the base body 168 and 170, respectively, and, as shown in FIG. 6, face toward one another and thus subdivide the hollow chamber 180 formed between the first profile parts 152, 154 and 156, 158 into four partial volumes, such that a convection of air in this cavity 180 is substantially suppressed.

FIGS. 7A to 7C again show by comparison different variations of first profile parts and the possibility to adapt the first profile parts to the respective installation conditions in a composite profile. The simplest variant of a first profile part 200 is shown in FIG. 7A, wherein the first profile part 200 has a base body 202 that extends substantially strip-shaped in a Z-direction and that has at both rim regions respective profile regions 204, 206 projecting from the same surface of the first profile part 200, which profile regions can be plasticized and deformed as part of an ultrasonic method in order to be able to be connected in positive engagement to associated second profile parts (not shown) provided with a corresponding receiving structure, as are depicted e.g. as part of FIG. 6 as second profile parts 156, 158.

This base geometry visible in FIG. 7A can be varied, as shown with FIGS. 7B and 7C, by further functional parts being able to be connected as one piece with the base body 202 of the first profile part shown in FIG. 7A with its base geometry, thus creating first profile parts, as have already been described in the context of FIG. 6 and have been depicted in an installation situation in FIG. 5.

As can be seen in FIG. 7C in comparison, functional elements can be arranged not only on the inwardly facing surface of the base bodies, but also on the visible side, such that, as in the example of FIG. 7C, an additional receptacle, for example for sealing elements to be attached on the outside, is formed on the base body 88 of the first profile part 82 by the angled projections 116, 118.

A further possible variation is depicted in FIG. 8 in the installed state of a composite profile 220 in accordance with the invention, in which, based on a first profile part 222, a further first profile part 224, and two second profile parts 226, 228, the composite profile 220 is produced in a manner similar to that described in the context of FIG. 6.

The first profile part 222 is based on the base structure of a first profile part 200, as depicted in FIG. 7A, this being equipped with a foam profile 230 on an inner surface 223 in the composite profile 220, which foam profile typically extends continuously in the longitudinal direction of the first profile part 222 and here fills a large portion of the hollow chamber 232 of the composite profile 220 and thus can also suppress convection effects. Alternatively, foam strips made of a thermoplastic material, for example polystyrene, polyamide, or polyester, may be adhesively affixed.

A further particularity is shown in FIG. 8 on the part of the first profile part 224, in which an additional profile region is provided that engages into a further groove 236 provided on the part of the second profile part 228, and there was plasticized and deformed to form a further positive engagement as part of a method in accordance with the invention. This modification improves, e.g., mechanical properties of the composite profile (in particular transverse tensile properties and displacement properties) and lead to a uniform visible surface.

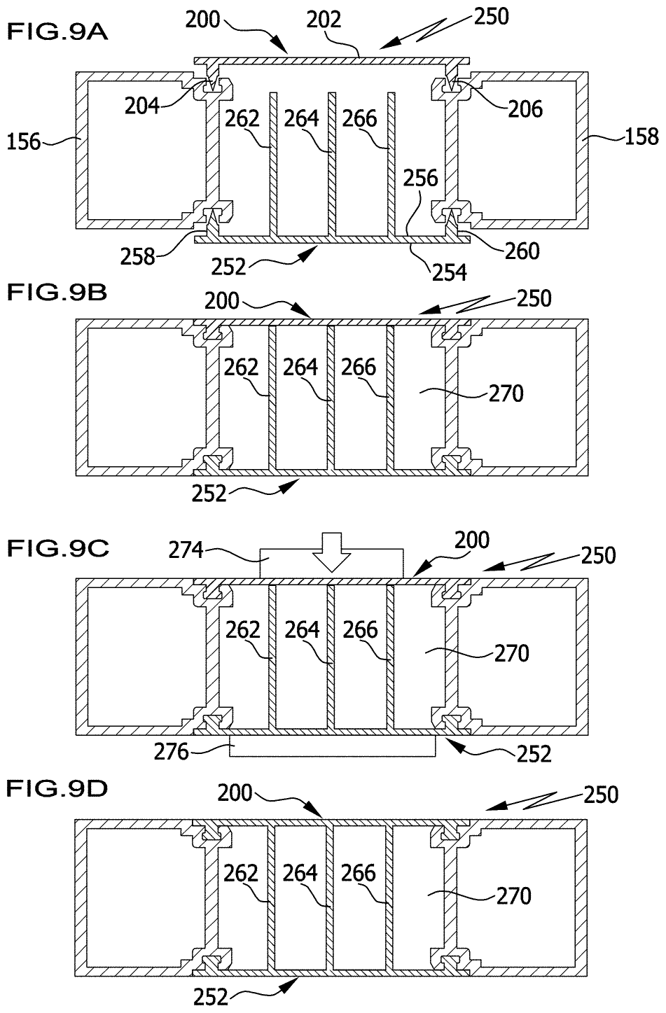

The production in accordance with the invention of a composite profile 250 in accordance with the invention is depicted in multiple steps in FIGS. 9A to 9D. The composite profile 250 contains the second profile parts 156, 158 made of metal, as were already described in the context of FIG. 6, and uses as one of the first profile parts a profile part 200, as was already described in the context of FIG. 7A. A further first profile part 252 is formed from a base body 254, which has a planar band-shaped structure extending in the Z-direction, as well as respective profile regions 258, 260 projecting from a surface 256 at the side regions. Also on the surface 256 of the first profile part 252 are web- or flag-like projections 262, 264, 266, which serve to subdivide a hollow volume 270 to be formed in the hollow profile into mutually separate volumes.

In a first method step, the two first profile parts 200, 252 placed on the second profile parts 156, 158—as already explained in detail in the preceding embodiments—are connected by positive engagement or form fit by plasticizing the profile regions 204, 206 and 258, 260, respectively, thus resulting in a structure as is depicted in FIG. 9B. Here, the flag-like projections 262, 264, 266 with their free ends contact the inward-facing surface of the first profile part 200, thereby already achieving a subdivision of the cavity 270 into four volume regions. The flags may thereby have a minimal overlength (e.g., 0.1 mm or more), so that there is a contact pressure as a result of the spring forces in the plastics material.

Furthermore, the flag-like projections 262, 264, 266 may be used to produce a positively engaging connection of the first profile part 252 to the other first profile part 200, and this, too, may take place as part of an ultrasonic welding, as is shown schematically in FIG. 9C. For this purpose, the composite profile 250 is introduced into a sonotrode apparatus, wherein a sonotrode 274 abuts against the outer surface of the first profile part 200 while a counter bearing 276 is arranged on the outer surface of the first profile part 252 and supports the composite profile 250 as a whole.

A one-piece structure made of the two first profile parts 200 and 252 is created after the ultrasonic welding, as is shown in FIG. 9D. The composite profile 250 has an improved transverse and winding rigidity, which is a result of the substance-to-substance bond of the two first profile parts 200 and 252 by way of the web-like projections 262, 264, 266. This welding may be performed simultaneously with or subsequent to the positive engagement or form fit.

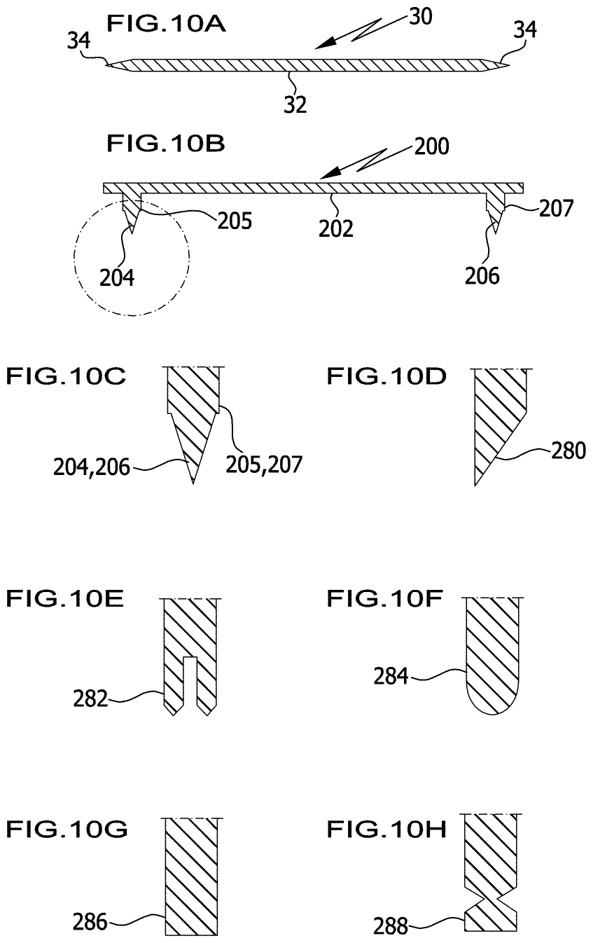

Depicted in FIGS. 10A and 10B as a reference are the two types of first profile parts 30 and 200, having a base body 32 and 202, respectively, and meltable profile regions 34 and 204, 206, respectively, arranged on both end regions. Here, the profile regions 204, 206 project substantially perpendicularly from the base body 202, though other angles are also possible. The profile regions 204, 206 have a greater wall thickness 205, 207 near the base body 202 than the base body 202 itself. This has advantageous effects both on the energy input (better input of the ultrasound) and on the mechanical strength of the composite profile, because higher forces, for example transverse tensile forces, can be transmitted due to the thicker portion.

On this basis, depicted in FIGS. 10C to 10H are the meltable profile regions in different variants, first in FIG. 10C, the meltable profile regions 204, 206 with a triangular form in cross section, as are used in conjunction with the embodiment of a first profile part 200.

A first alternative of this is shown in FIG. 10D in the form of a meltable profile region 280 that has a wedge shape. Shown in FIG. 10E is a further alternative of a meltable profile region 282 with a double tip that is separated by a gap. A further alternative is shown in FIG. 10F, with a rounded tip, as has already been shown and described in the context of FIG. 5B.

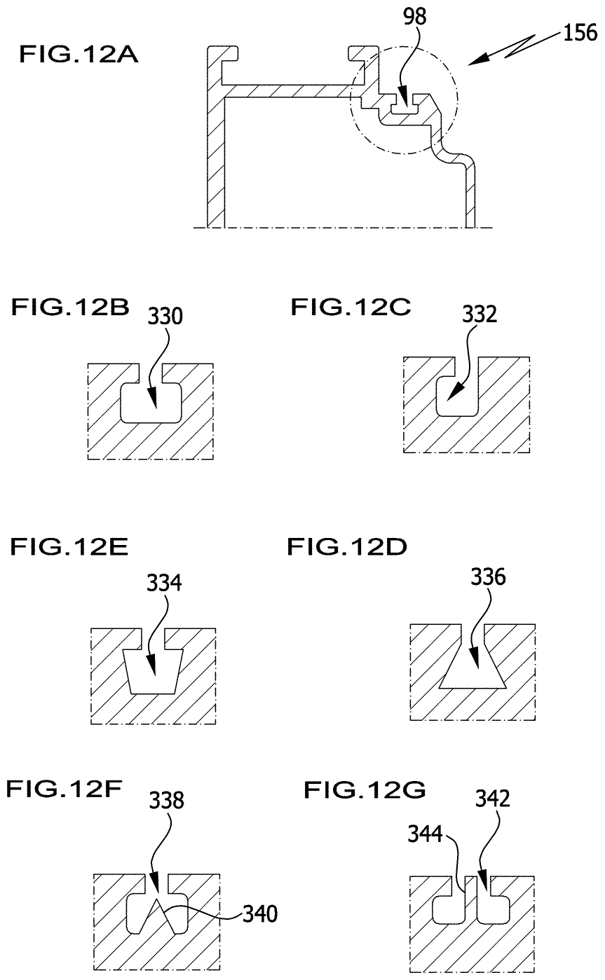

A further possibility for the configuration of the meltable profile region is shown in FIG. 10G in the form of the profile region 286, which is preferably combined with a specially adapted receiving structure (e.g. FIG. 12F), because it itself has no structure with which the inputted ultrasonic energy can be focused. Furthermore, a possibility for configuring a meltable profile region is depicted in FIG. 10H in the form of a profile region 288, in which a focusing of the ultrasonic energy takes place in the region of the waisting/taper. The features of the melting elements can be combined and adapted in a variety of ways, for example in their length, width, and aspect ratio.

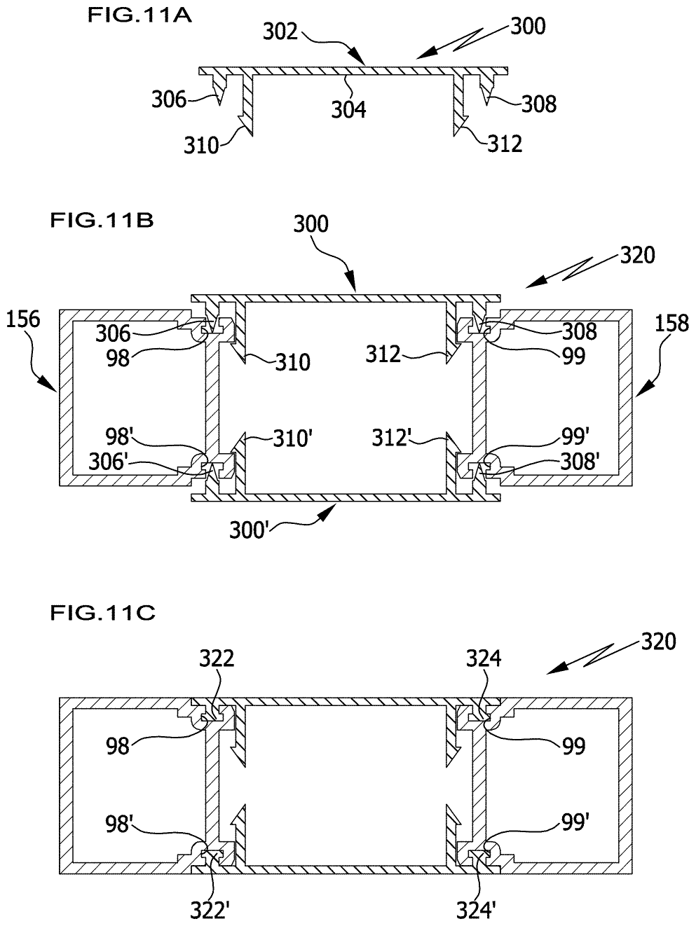

Depicted in FIG. 11A is a further variant of a first profile part 300, which comprises a base body 302 as well as meltable profile region 306, 308 arranged on the surface 304 thereof, as were shown and described in the context of profile part 200, for example in FIG. 10B.

The first profile part 300 is distinguished from the other variants described so far by additional functional elements 310, 312 being arranged (here moulded on in one piece) as assembly aids on the surface 304 from which the profile regions 306, 308 already project as meltable projections, said functional elements ending with a hook-shaped projection.

FIG. 11B shows the use of these first profile parts 300 in the production of a composite profile 320 in accordance with the invention, wherein the second profile parts 156, 158 are again used in addition to the two first profile parts 300, 300′.

In a first step of the method in accordance with the invention for producing the composite profiles in accordance with the invention, the two first profile parts 300, 300′ are brought together with the two second profile parts 156, 158, now thus obtaining a structure that can be easily handled due to the assembly aids in the form of the hook-shaped projections 310, 312 and 310′, 312′, respectively, thereby significantly simplifying the process of producing a positively engaging connection during the ultrasonic welding. The projections 310, 312 and 310′, 312′ also aid in the exact positioning and centering of the joining partners.

The completed structure of the composite profile 320 connected by positive engagement is depicted in FIG. 11C, in which the profile regions 306, 308 and 306′, 308′ positively engage into the grooves 98, 99, and 98′, 99′, respectively, provided by the two second profile parts 156, 158 and form the positive engagement or form fit structures 322, 324, and 322′, 324′, respectively.

FIG. 12A again shows a section of a second profile part 156 with a groove 98 as a receiving structure for the plastically deformed second polymeric material of a profile region of the first profile part.

The following FIGS. 12A to 12G show variations that are possible with such specific receiving structures.

FIG. 12B shows a symmetrical receiving structure 330, this structure being configured similarly to the groove 98 in FIG. 12A, but having a larger volume.

Shown in FIG. 12C is a further variant of an asymmetrical receiving structure in the form of a groove 332, in which, unlike in the groove 330 or the groove 98, an undercut is formed only on one side.

In the embodiment for a receiving structure of FIG. 12E, on the other hand, a groove 334 with a symmetrical cross section is provided, which has a trapezoidal cross sectional structure. Again in FIG. 12D, a symmetrical receiving structure in the form of a groove 336 is shown, which has a substantially triangular structure in cross section.

Shown in FIG. 12F is a variant of a receiving structure from FIG. 12D in which a projection 340 that is triangular in cross section is arranged in the groove 338 centrally on the base of the groove 338, said groove, upon the insertion of a profile region of a first profile part, for example as shown in FIGS. 10E, 10F, 10G, and 10H, ensuring a centering, diverting the plasticized molten material, and moreover also causing a focusing of the ultrasonic energy of the sonotrode to the free end of the profile region of the first profile part that is introduced in this receiving structure or groove 338.

In a similar form, this also applies to FIG. 12G, in which a receiving structure is provided in the second profile part in the form of a groove 342, which in turn is formed symmetrically and comprises a projection 344 in the center, which, like the projection 340 shown in FIG. 12F that is triangular in cross section, may serve to center or guide a profile region of a first profile part, in particular a profile region as shown in FIG. 10E.

The above special embodiments for receiving structures show that a large variation is possible with the groove-shaped receiving structures, which, for one, can take into account a possibly limited amount of space in the cross section of the second profile part 156 and/or can achieve further improvements in the production of the positive engagement.

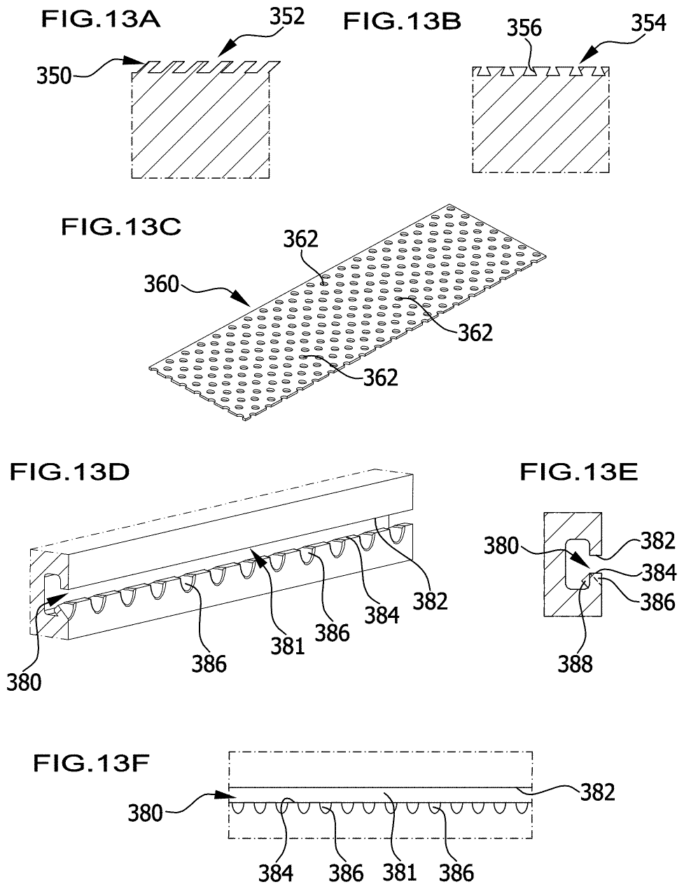

Further variants for receiving regions of second profile parts are shown in FIGS. 13A to 13F.

In FIG. 13A, a receiving structure is shown which is equipped with a multitude of small projections 352 inclined in relation to the surface 350, into which the second plastics material can penetrate upon the plasticization and deformation of a profile region, and thus can create a positive engagement. The arrangement of these projections may be regular or irregular with equal or alternating angles.

An alternative is shown in FIG. 13B, in which the receiving structure 354 has a multitude of trapezoidal set-back portions 356, which ensure a sufficient positive engagement upon the formation of a positive engagement between a first and a second profile part, or the profile region of the first profile part and the second profile part.

FIG. 13C shows a further alternative of a receiving structure 360 in the form of a perforated sheet-like portion or section, wherein the second plastics material of a profile region of a first profile part can enter and pass through the through-openings 362, optionally form a thicker portion, and thus also ensure a positive engagement after the second plastics materials cools.

A further variant of a groove-shaped receiving structure 380 is shown in FIGS. 13D to 13F in multiple perspectives. FIG. 13D shows the receiving structure 380 in a perspective depiction, wherein it can be seen that the entry gap 381 for the groove that widens toward the bottom is delimited on one side with a smooth wall surface 382, while on the opposite side the wall surface has a knurled structure 386, i.e., here, the wall surface is retroactively deformed after the formation of the receiving structure 380, so that a series of regularly arranged indentations arise and material is, in part, pressed into the lower region of the receiving structure 380 in the form of wave-shaped raised portions 388.

FIG. 13F shows this specific embodiment of a receiving structure 380 again in a plan view.

Due to the specially designed structure, in particular on the part of the surface 384, when a second plastics material penetrates in a positively engaging manner upon the formation of a positive engagement by a melting profile region of a first profile part, a positive engagement is achieved not only by way of the actual receiving structure 380, but also a particularly high shear strength is achieved by second plastics material also possibly being introduced into the bulges or notches of the knurled structure 386 on the part of the surface 384.

In particular, the downward facing tips 388 (cf. FIG. 13E) lead to a significant increase in the shear strength of the connection in the longitudinal direction of the receiving structure 380, because this structure is surrounded very well by the plasticized molten material during the formation of the positive engagement or form fit.

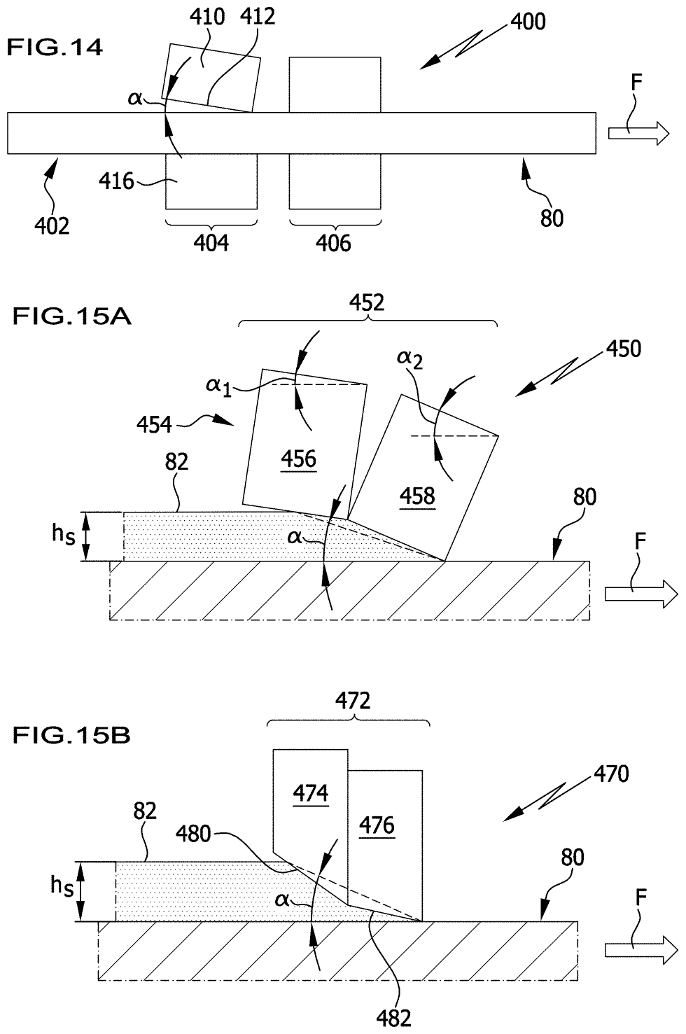

FIG. 14 schematically depicts a first variant of an apparatus 400 for carrying out the method in accordance with the invention for producing composite profiles.

The apparatus 400 has a first guidance zone 402 (guidance elements not shown) in which the initially separately produced profile parts of a composite profile to be connected to one another, using the example of the composite profile 80 in FIG. 5A a first profile part 82 and two second profile parts 84, 86, are brought together in a predetermined orientation. Then the profile parts 82, 84, 86 are fed in a conveying direction F to a subsequently arranged welding zone 404 and an ultrasonic welding apparatus located therein.

Following the welding zone 404 in the conveying direction F is a holding zone 406, which holds the profile parts 82, 84, 86, which were brought together and connected by positive engagement in the welding zone 404, as a finished composite profile 80 in their relative position to one another so that the plasticized and deformed second plastics material 106, 108 can cool and thus the produced positive engagement can solidify.

A sonotrode 410 arranged in the welding zone 404 is, in FIG. 14, arranged with its contact surface 412 at an acute angle α relative to the longitudinal direction of the profile parts of the composite profile 80, said angle being selected smaller than, e.g., about 5°, in particular smaller than about 3°. In the welding zone 404, the sonotrode 410 can exert a force perpendicular to the surface of the composite profile 80, thereby aiding in the deformation of a profile region or the profile regions 94, 96 of the first profile part 82 of the composite profile 80. The first profile part 82 is thereby lowered by a lowering height h_{S} against the second profile parts 84, 86, as was already illustrated in the sequence of FIGS. 4A to 4D. The profile parts of the composite profile 80 are thereby supported by a support 416 in the welding zone 404. The first and second profile parts 84, 86 are thus arranged in the predetermined arrangement to one another upon entry into the holding zone 406.

Due to the shown geometric arrangement of the sonotrode 410 in relation to the support 416 (counter bearing) and the conveying direction F, the material of a profile region 94, 96 can be continuously plasticized and promptly pressed in the plasticized state such it that can enter into the receiving structures (grooves 98, 99) of the second profile parts 84, 86, fill same, and thus form a positive engagement or form fit 106, 108 between the first profile part 82 and the second profile parts 84, 86.

FIG. 15A shows a second variant of an apparatus 450 for carrying out the method in accordance with the invention for producing composite profiles in accordance with the invention.

Here, a sonotrode arrangement 454 with two sonotrodes 466, 458 is used in a welding zone 452, which sonotrodes are controllable and operable independently of one another, wherein the two sonotrodes 456, 458 of the sonotrode arrangement 494 are aligned with their contact surfaces at different angles α₁ and α₂ to the transport plane of the composite profile 80. The angle α₁ is selected smaller than the angle α₂. An average contact angle α arises over the entire course of the sonotrode contact. Here, a successively increasing introduction of force into the composite profile 80 and its profile parts take place, which, due to the use of two sonotrodes 474, 476, can be more easily adapted to the material properties and the geometry of the second plastics material of the profile region(s) 94, 96, as well as the feed-through speed of the composite profile 80.

An alternative design of a welding zone 472 as part of an apparatus 470 is depicted in FIG. 15B. Here, too, two sonotrodes 474, 476 are used in the welding zone 472. The sonotrodes 474, 476 are arranged in parallel to one another, but have contact surfaces 480, 482 formed at different angles α₁ and α₂ (in relation to the transport plane or the conveying direction F). A contact angle α arises over the entire course of the sonotrode contact. In this embodiment, the angle α₁ is selected larger than the angle α₂.

A holding zone with a guidance apparatus (not shown) is provided following each welding zone 452 and 472, said holding zone holding the elements of the composite profile 80, connected to one another by positive engagement, in the desired cross sectional geometry, such that the formed positive engagement can cool and finally a handleable composite profile 80 with the desired geometry is obtained.

A further variant of an apparatus 500 for producing, in accordance with the invention, a composite profile 80 in accordance with the invention is schematically shown in FIG. 16. By way of a first guidance apparatus (not shown), two first profile parts 82, 82′ and two second profile parts 84, 86 are oriented in the configuration of the composite profile 80 to be achieved and are fed to a welding zone 502.

The welding zone 502 is equipped with two sonotrodes 504, 506, which are arranged opposite one another above and below the composite profile 80. The sonotrodes 504, 506 each form a counter bearing or a support for one another. Both sonotrodes 504, 506 are arranged with their contact surfaces 508, 510 at an angle α to the conveying direction F. The profile parts of the composite profile can thereby be brought together in their positions in the completed composite profile substantially in parallel to the energy input and the plasticization of the second plastics material of the meltable profile regions of the first profile parts.

The welding zone 502 is followed in the conveying direction F by a holding zone 512 in which the plasticized and deformed profile regions can cool and harden while preserving the positive engagement with the second profile parts.

With this apparatus variant, both first profile parts can be connected by positive engagement to both second profile parts in one step and simultaneously.

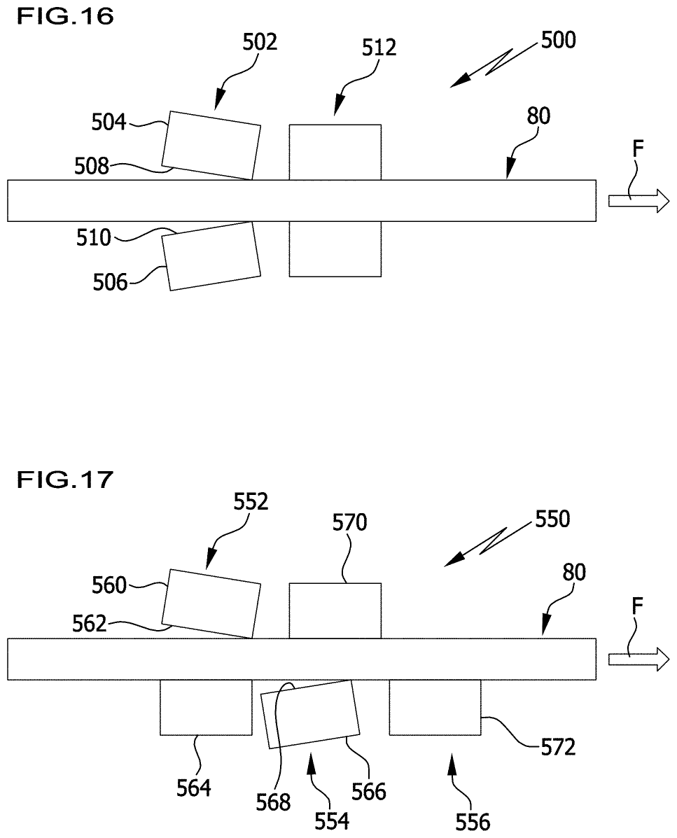

In a further embodiment of an apparatus 550 for carrying out the method in accordance with the invention according to FIG. 17, two successive welding zones 552, 554 are provided. In the first welding zone 552, a sonotrode 560 is arranged above the composite profile 80 with its contact surface 562 inclined at an angle α to the conveying direction F.

Provided opposite the sonotrode 560 is a support 564, which supports the composite profile or its profile parts when passing through the sonotrode 560.

Following that, the second welding zone 554 is provided with a second sonotrode 566, which is arranged below the composite profile 80 and has a contact surface 568 that is also oriented inclined at an angle α to the conveying direction F.

Arranged opposite the sonotrode 566 is a guide block 570, which, for one, absorbs the pressure exerted by the sonotrode 566 and, for another, together with a further support 572 forms a holding apparatus that supports and guides the composite profile 80 in the final joined and positively engaged state during the cooling and solidifying of the positive engagement elements formed in the welding zones.

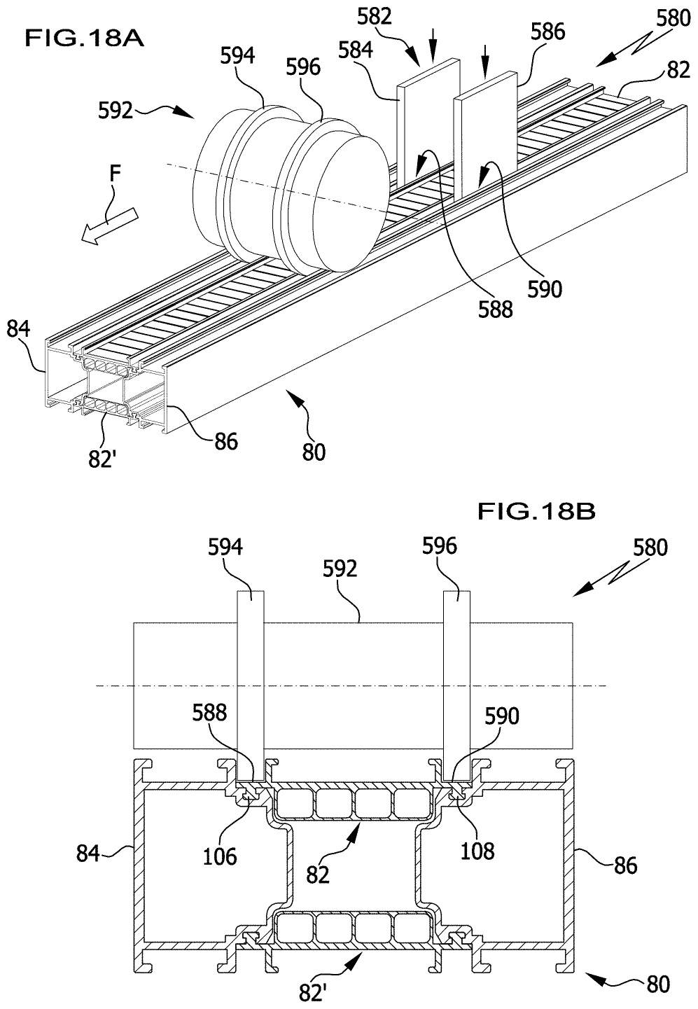

FIGS. 18A and 18B show a possible concrete embodiment of a welding and holding apparatus 580 as part of the production of a composite profile 80. Here, the part of the composite profile 80 first loosely brought together (as shown e.g. in FIGS. 4A and 4B) in a holding apparatus (not shown) are fed to a welding zone 582, in which two parallel sonotrode segments 584, 586 are arranged that press with their contact surfaces 588 and 590, respectively, on the upper surface of the first profile part 82 and thus transmit the ultrasonic energy to the first profile part 82, opposite the profile regions 94, 96 that engage into a corresponding groove 98 and 99, respectively, of the part of the second profile parts 84, 86 (corresponding to the depiction in FIG. 4C).

The composite profile 80 or its constituent parts 82, 82′, 84, 86 are conveyed in the conveying direction F to a holding apparatus that here is configured schematically with a roller 592, which has on its outer periphery two annular projections 594, 596 spaced in parallel to one another that, like the two sonotrodes 584, 586, engage in a matching manner into the surface structure of the composite profile 82 and hold the plasticized profile regions 94, 96 in form so that a positive engagement 106, 108 with the first profile part 82 can form in the receiving grooves 98, 99 of the second profile parts 84, 86. A plurality of rollers 592 may also be arranged in series.

The supports or counter bearings discussed in the preceding FIGS. 14 to 17 are necessary here as well, but are not shown for simplicity.

FIG. 18B shows the apparatus 580 in a plan view seen from the finished end of the composite profile 80, again showing how the projections 594, 596 of the roller 592 engage into the structure of the upper side of the composite profile 80 in order to complete the deformation of the profile regions 94, 96 there and to hold them while cooling.

A feed-through speed or a withdrawal speed of the finished insulating profile 80 is typically within the range of about 3 m/min or more, whereby significantly higher values are also realizable, for example about 10 m/min or more.

The dwell times of the profile parts in the welding zone that are predetermined by the aforementioned withdrawal speeds are heavily dependent on the material and the geometry and typically amount to about 0.2 sec to about 5 sec. If a higher energy input should be necessary, then one can work with somewhat lower withdrawal speeds (thus corresponding to a longer dwell time) so that, upon passing through the welding zone, a higher input of energy (taken with reference to the unit of length of the positive engagement) can take place. In general, with significantly higher withdrawal speeds, an extension of the welding zone becomes necessary, for example by adding further sonotrodes, something that typically can easily be realized, however, in the method in accordance with the invention.

The duration of the compression process, i.e., the period in which the composite profile connected by positive engagement is guided and stabilized by a holding apparatus, is conceived on the basis of the time that is required in order to let the plastics material solidify and to make the composite profile able to be handled as such. Here, typically durations of about 0.2 sec to a few seconds are sufficient, because the plasticization is limited and the amount of heat that has to be dissipated is relatively small and, in addition, in the case that metal profile parts are used as second profile parts, a good heat dissipation is ensured.

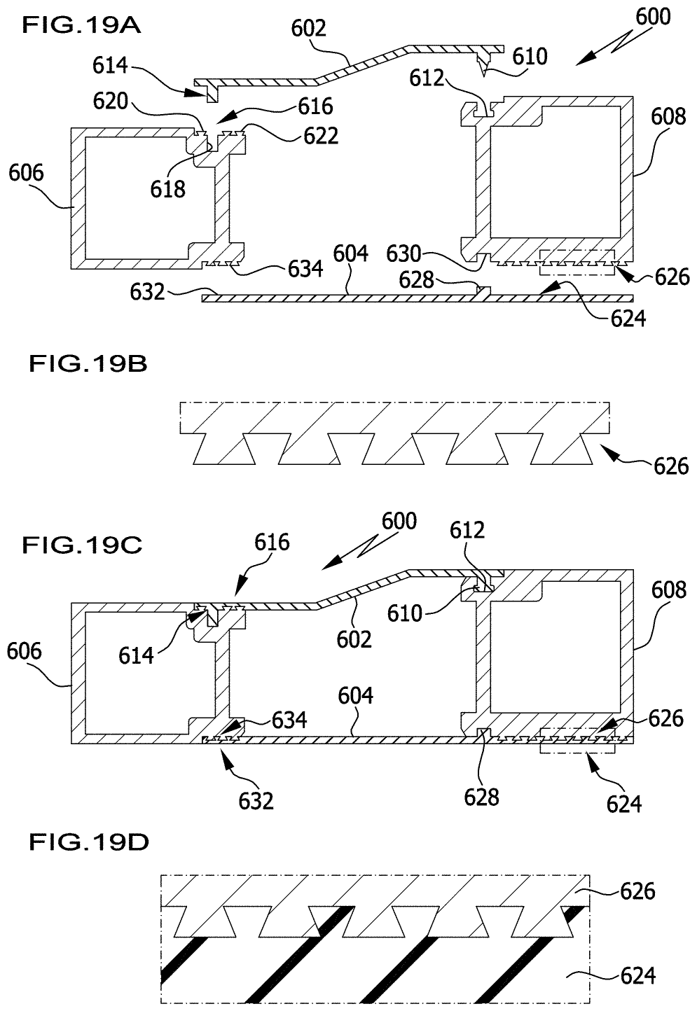

In FIGS. 19A to 19D, a further variant of a composite profile 600 in accordance with the invention and the production thereof is explained, which show how versatilely the method in accordance with the invention can be implemented and how versatilely the structures that are able to be produced therewith can be configured.

In FIG. 19A, the constituent parts for a composite profile 600 are depicted, namely a first profile part 602, a second profile part 604, and two second profile parts 606 and 608.

The first profile part 602 has a first profile region 610, which, as already described in the context of various embodiments, can be plasticized and inserted into a groove-shaped recess 612 on the part of the second profile 608 and be connected by positive engagement.

Provided on the opposite side of the first profile part 602 is a further profile region 614, the second plastics material of which is also plasticized in accordance with the invention and is brought into positive engagement with a receiving structure 616 on the part of the second profile part 606. The receiving structure 616 differs from the receiving structure of the groove 612 in that there are separate structures for absorbing transverse tensile forces and for forming the positive engagement and, for one, only one set-back portion 618 without undercuts is provided, into which the profile region 614 can partially engage. For another, in each case structured surface regions 620, 622 adjacent to the set-back portion 618 are provided on the surface of the profile part 606, in which surface regions a multitude of undercuts are provided, such that the material plasticized on the part of the profile region 614 is able to penetrate into the structures of the surfaces region 620, 622 in order to achieve a positive engagement. The structured regions 620, 622 serve primarily to fix the first profile part 602 to the second profile part 606, while the remaining projection from the profile region 614 that engages into the set-back portion 618 is designed to absorb tensile forces that may arise in the width direction of the first profile part 602.

There is a similar functionalization on the part of the further first profile part 604, in which a profile region 624 is provided that is brought into contact with a receiving structure 626 on the part of the second profile part 608 and ultimately forms a positively engaging connection therewith. In addition hereto, provided on the same side of the first profile part 604 is a strip-shaped projection 628, which, when joining the first profile part 604 to the second profile part 608, engages into a set-back portion 630 in order to absorb primarily transverse tensile forces.

On the other side of the first profile part 604 is a profile region 632, which can be brought into contact with a receiving structure with a multitude of undercuts 634 on the part of the second profile part 606 and thereby is shaped into a positively engaging connection as part of the plasticization and the bringing together of the two profile parts.

The receiving structure with the multitude of undercuts, as it is used in the receiving structures 620, 622, 626, and 634, is depicted in an enlarged view again in cross section in FIG. 19B as part of a section of the receiving structure 626.

Receiving structures of that kind can be introduced, e.g., by means of an extrusion process even into aluminum profiles, or in other forms by means of surface finishing steps, for example by means of mechanical, chemical/physical surface finishing.

FIG. 19C shows the composite profile 600 in the completely assembled state of its profile parts including the positively engaging connections of the profile regions 610, 614, 624, and 632, on the one hand, and the receiving structures 612, 618, 620, 622, 626, and 634, on the other hand, that are thereby achieved.

FIG. 19D again shows in supplement to FIG. 19B the receiving region 626 structured with undercuts, after the second plastics material of the profile region 624 was plasticized and introduced into the receiving structure 626 and thereby formed the positive engagement or form fit after solidifying.

1. A method for producing a composite profile extending in a longitudinal direction, comprising
providing a first profile part extending in a longitudinal direction, made from a first plastics material, with a profile region, wherein the profile region of the first profile part is produced from a second plastics material that is thermally plasticizable at a first temperature T₁,
providing a second profile part extending in a longitudinal direction, which is produced from a material that is not thermally plasticizable at the first temperature T₁, wherein the second profile part has a receiving structure formed along the longitudinal direction of the second profile part, to which the profile region of the first profile part is connectible by positive engagement,
bringing the profile region of the first profile part into contact with the receiving structure of the second profile part,
plasticizing the second plastics material of the profile region of the first profile part by heating to the first temperature T₁ and
deforming the plasticized second plastics material of the profile region of the first profile part while forming a positive engagement between the profile region of the first profile part and the receiving structure of the second profile part, wherein the receiving structure has a geometry that remains substantially unchanged during formation of the positive engagement.

2. The method in accordance with claim 1, wherein the receiving structure is formed with a receiving region extending in the longitudinal direction.

3. (canceled)

4. The method in accordance with claim 1, wherein the profile region of the first profile part is configured as a projecting profile region.

5. The method in accordance with claim 1, wherein the first profile part is formed with a second profile region made from the second plastics material, said profile region extending in parallel to the first profile region at a predetermined distance in the longitudinal direction of the first profile part.

6. The method in accordance with claim 5, wherein a third profile part extending in a longitudinal direction, made from a material that is not thermally plasticizable at the first temperature T₁, is provided, wherein the third profile part comprises a receiving structure extending in the longitudinal direction thereof, and wherein the second profile region is brought into contact with the receiving region of the third profile part substantially simultaneously with or temporally offset from the first profile region being brought into contact with the receiving region of the second profile part, is plasticized, and is deformed while forming a positive engagement.

7. The method in accordance with claim 1, wherein the material of the second and/or third profile part that is not thermally plasticizable at the first temperature T₁ is selected from a metallic material, a ceramic material, glass, wood, a thermoplastic material with a melting point or a glass transition temperature above the first temperature T₁ and a thermosetting plastics material.

8. The method in accordance with claim 1, wherein the thermally plasticizable second plastics material is selected from thermoplastic polymeric materials on the basis of polyamides, polyimides, polyesters, polyolefins, polyketones, vinyl polymers, polyether, polycarbonate, polyphenylene sulfide and the mixed forms thereof, and polyetherimides, as well as copolymers and blends thereof.

9. The method in accordance with claim 1, wherein the first and/or the second plastics material contain(s) fillers and/or reinforcing substances, which in particular are selected from glass fibers, metal fibers, carbon fibers, plastic fibers, mineral fibers, and mixtures thereof.

10. The method in accordance with claim 1, wherein the first and the second plastics material are based on the same polymeric material.

11. (canceled)

12. The method in accordance with claim 1, wherein the method steps of bringing the profile region(s) of the first profile part into contact with the receiving structure(s) of the second and the third profile part, the plasticization, and the deformation are performed continuously.

13. The method in accordance with claim 1, wherein the positive engagement or the positive engagements is/are produced with a shear strength in the longitudinal direction of the composite profile of about 2 N/mm or more.

14. The method in accordance with claim 1, wherein the plasticization of the second plastics material is effected by ultrasound, using one or more sonotrodes.

15. (canceled)

16. The method in accordance with claim 1, wherein the second profile part and/or a third profile part are provided with a receiving structure in the form of a recess which, seen in cross section perpendicular to the longitudinal direction of the composite profile, has an undercut at least in sections.

17. The method in accordance with claim 1, wherein the cross section of the receiving structure of the second profile part and/or a third profile part, seen perpendicular to the longitudinal direction of the composite profile, varies in its width and/or depth along the longitudinal direction.

18. The method in accordance with claim 1, wherein, before the plasticization of the profile region or the profile regions, the first profile part and the second and a third profile part are positioned by means of a first guidance apparatus in a predetermined, variable relative position to one another and are guided in the longitudinal direction of the composite profile.

19. The method in accordance with claim 1, wherein, after the plasticization and deformation of the profile region(s), the first profile part and the second and/or a third profile part are positioned by means of a second guidance apparatus in a predetermined, or a variable relative position to one another and are guided in the longitudinal direction.

20. The method in accordance with claim 1, wherein, after the plasticization and deformation of the profile region(s), the first profile part and the second and/or a third profile part are pressed against one another with a predetermined force and then are held in the same or in a further predetermined relative position until the plasticized second plastics material has solidified.

21. The method in accordance with claim 1, wherein, after the plasticization and deformation of the profile region(s), the first profile part and the second and/or a third profile part are pressed against one another in a predetermined relative position and then are held in the same or in a further predetermined relative position until the plasticized second plastics material has solidified.

22. The method in accordance with claim 1, wherein the profile region(s) of the first profile part is/are configured as a projection or projections, which extends/extend from a surface of the first profile part by about 10 mm or less.

23. (canceled)

24. The method in accordance with claim 1, wherein the plasticization is performed in a zone by sonication, wherein a sonotrode thereby has a direct contact to one of the first, second and/or a third profile part(s).

25. The method in accordance with claim 1, wherein a zone for the plasticization, measured in the longitudinal direction of the composite profile, has a length of about 5 cm to about 100 cm.

26. The method in accordance with claim 14, wherein a contact surface(s) of the sonotrode(s) in a zone of plasticization and deformation, in relation to the longitudinal direction of the first, second and/or a third profile part(s) in contact with the sonotrode(s), are at a distance from a surface of the other profile part(s) of the composite profile, said distance decreasing along the longitudinal direction of the composite profile seen in the feed-through direction.

27. (canceled)

28. The method in accordance with claim 14, wherein the sonotrode used in a zone of plasticization and deformation is a static sonotrode.

29. The method in accordance with claim 1, wherein the produced composite profile is conveyed at a speed of about 3 m/min or more in the longitudinal direction of the composite profile.

30. The method in accordance with claim 1, wherein a dwell time of the profile parts in a zone of plasticization and deformation is about 0.1 sec to about 10 sec.

31. (canceled)

32. A composite profile, produced according to a method in accordance with claim 1.

33-38. (canceled)

39. The method of claim 1, wherein the composite profile is produced with a length of at least 50 cm.

40. The method of claim 4, wherein the profile region is configured as a projecting profile region as a continuous projection extending in the longitudinal direction of the first profile part or as a plurality of projecting segments arranged one behind the other in the longitudinal direction of the first profile part spaced at a distance from one another.

41. The method of claim 1, wherein the method steps of bringing the profile region(s) of the first profile part into contact with the receiving structure(s) of the second and the third profile part, the plasticization, and the deformation are performed intermittently.

42. The method of claim 24, wherein the plasticization is performed in a zone by sonication in a zone in a nearfield method.

43. The method of claim 24, wherein the sonotrode is arranged at a distance of about 10 mm or less.

44. The method of claim 28, wherein the static sonotrode is a dragging sonotrode.
